(19) United States
(12) Patent Application Publication
(10) Pub. No.: US 2025/0015847 A1
(43) Pub. Date: Jan. 9, 2025

(54) TECHNIQUES FOR ENHANCED SIDELINK FEEDBACK TRANSMISSION

(71) Applicant: QUALCOMM Incorporated, San Diego, CA (US)

(72) Inventors: Shaozhen GUO, Beijing (CN); Jing SUN, San Diego, CA (US); Changlong XU, Beijing (CN); Xiaoxia ZHANG, San Diego, CA (US); Hao XU, Beijing (CN); Luanxia YANG, Beijing (CN); Siyi CHEN, Beijing (CN)

(21) Appl. No.: 18/707,127

(22) PCT Filed: Dec. 31, 2021
(86) PCT No.: PCT/CN2021/143532

§ 371 Date: May 2, 2024

(51) Int. Cl. H04B 7/0456; H04L 5/00; H04W 72/25

(52) U.S. Cl. CPC H04B 7/0456; H04L 5/0055; H04W 72/25

(57) ABSTRACT

Methods, systems, and devices for wireless communications are described. A first wireless device may monitor a set of physical sidelink shared channel (PSSCH) resources for sidelink messages from a second wireless device. The first wireless device may generate one or more codebooks that include acknowledgement (ACK) or negative acknowledgement (NACK) bits corresponding to the sidelink messages. The first wireless device may transmit one or more feedback messages to the second wireless device on one or more physical sidelink feedback channel (PSFCH) resources in accordance with a sidelink feedback configuration of the first wireless device. The one or more feedback messages may include an indication of the one or more codebooks. The techniques described herein may enable the first wireless device to transmit the one or more feedback messages to the second wireless device with higher throughput and greater signaling efficiency, among other benefits.

### CROSS REFERENCE

The present Application is a 371 national stage filing of International PCT Application No. PCT/CN2021/143532 by GUO et al. entitled “TECHNIQUES FOR ENHANCED SIDELINK FEEDBACK TRANSMISSION,” filed Dec. 31, 2021, which is assigned to the assignee hereof, and which is expressly incorporated by reference in its entirety herein.

### FIELD OF TECHNOLOGY

The following relates to wireless communications, including techniques for enhanced sidelink feedback transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a first wireless device may transmit sidelink feedback information to a second wireless device on physical sidelink feedback channel (PSFCH) resources. For example, the first wireless device may transmit one or more acknowledgement (ACK) or negative acknowledgement (NACK) bits corresponding to one or more sidelink messages from the second wireless device. In some cases, however, the first wireless device may be unable to transmit more than one ACK or NACK bit per PSFCH resource, which may result in lower throughput and reduced signaling efficiency at the first wireless device.

### SUMMARY

The described techniques relate to improved methods, systems, devices, and apparatuses that support techniques for enhanced sidelink feedback transmission. Generally, the described techniques provide for improving the throughput and signaling efficiency of sidelink feedback transmissions from a wireless device. In some examples, a first wireless device may monitor a set of physical sidelink shared channel (PSSCH) resources for sidelink messages from a second wireless device. The first wireless device may generate one or more codebooks that include acknowledgement (ACK) or negative acknowledgement (NACK) bits corresponding to the sidelink messages. The first wireless device may transmit one or more feedback messages to the second wireless device on one or more physical sidelink feedback channel (PSFCH) resources in accordance with a sidelink feedback configuration of the first wireless device. The one or more feedback messages may include an indication of the one or more codebooks. The techniques described herein may enable the first wireless device to transmit the one or more feedback messages to the second wireless device with higher throughput and greater signaling efficiency, among other benefits.

A method for wireless communications at a first wireless device is described. The method may include monitoring multiple sidelink resources for multiple sidelink messages from a second wireless device, generating one or more codebooks including multiple ACK or NACK bits corresponding to the multiple sidelink messages, and transmitting a set of feedback messages to the second wireless device over a set of feedback resources in accordance with a sidelink feedback configuration of the first wireless device, the set of feedback messages including an indication of the one or more codebooks.

An apparatus for wireless communications at a first wireless device is described. The apparatus may include a processor, memory coupled with the processor, and instructions stored in the memory. The instructions may be executable by the processor to cause the apparatus to monitor multiple sidelink resources for multiple sidelink messages from a second wireless device, generate one or more codebooks including multiple ACK or NACK bits corresponding to the multiple sidelink messages, and transmit a set of feedback messages to the second wireless device over a set of feedback resources in accordance with a sidelink feedback configuration of the first wireless device, the set of feedback messages including an indication of the one or more codebooks.

Another apparatus for wireless communications at a first wireless device is described. The apparatus may include means for monitoring multiple sidelink resources for multiple sidelink messages from a second wireless device, means for generating one or more codebooks including multiple ACK or NACK bits corresponding to the multiple sidelink messages, and means for transmitting a set of feedback messages to the second wireless device over a set of feedback resources in accordance with a sidelink feedback configuration of the first wireless device, the set of feedback messages including an indication of the one or more codebooks.

A non-transitory computer-readable medium storing code for wireless communications at a first wireless device is described. The code may include instructions executable by a processor to monitor multiple sidelink resources for multiple sidelink messages from a second wireless device, generate one or more codebooks including multiple ACK or NACK bits corresponding to the multiple sidelink messages, and transmit a set of feedback messages to the second wireless device over a set of feedback resources in accordance with a sidelink feedback configuration of the first wireless device, the set of feedback messages including an indication of the one or more codebooks.

In some examples of the method, apparatuses, and non-transitory computer-readable medium described herein, generating the one or more codebooks may include operations, features, means, or instructions for generating a joint codebook that includes the multiple ACK or NACK bits corresponding to the multiple sidelink messages that may be associated with different priority levels, different group indices, or both.

In some examples of the method, apparatuses, and non-transitory computer-readable medium described herein, generating the joint codebook may include operations, features, means, or instructions for generating a first subset of the joint codebook that includes ACK or NACK bits corresponding to a first subset of sidelink messages from the multiple sidelink messages, the first subset of sidelink messages associated with a first priority level and generating a second subset of the joint codebook that includes ACK or NACK bits corresponding to a second subset of sidelink messages from the multiple sidelink messages, the second subset of sidelink messages associated with a second priority level that may be different from the first priority level.

In some examples of the method, apparatuses, and non-transitory computer-readable medium described herein, generating the joint codebook may include operations, features, means, or instructions for generating a first subset of the joint codebook that includes ACK or NACK bits corresponding to a first subset of sidelink messages from the multiple sidelink messages, the first subset of sidelink messages associated with a first group index and generating a second subset of the joint codebook that includes ACK or NACK bits corresponding to a second subset of sidelink messages from the multiple sidelink messages, the second subset of sidelink messages associated with a second group index.

In some examples of the method, apparatuses, and non-transitory computer-readable medium described herein, the first group index corresponds to a set of priority levels that may be below a sidelink priority threshold and the second group index corresponds to a set of priority levels that may be above the sidelink priority threshold.

Some examples of the method, apparatuses, and non-transitory computer-readable medium described herein may further include operations, features, means, or instructions for concatenating different subsets of the joint codebook in ascending order or descending order with respect to priority level or group index.

In some examples of the method, apparatuses, and non-transitory computer-readable medium described herein, transmitting the set of feedback messages may include operations, features, means, or instructions for transmitting an indication of the joint codebook over a PSFCH resource in accordance with the sidelink feedback configuration.

In some examples of the method, apparatuses, and non-transitory computer-readable medium described herein, the multiple sidelink messages may be associated with a respective multiple priority levels, a respective multiple group indices, or both and the sidelink feedback configuration indicates a sidelink priority threshold, a first mapping between the respective multiple priority levels and the one or more codebooks, a second mapping between the respective multiple group indices and the one or more codebooks, or a combination thereof.

In some examples of the method, apparatuses, and non-transitory computer-readable medium described herein, the multiple sidelink messages may be multiplexed with respective instances of sidelink control information (SCI).

In some examples of the method, apparatuses, and non-transitory computer-readable medium described herein, each respective instance of SCI includes an indication of a counter sidelink assignment index and a total sidelink assignment index associated with a sidelink message from the multiple sidelink messages.

In some examples of the method, apparatuses, and non-transitory computer-readable medium described herein, the counter sidelink assignment index and the total sidelink assignment index may be specific to a priority level, a group index, or both.

In some examples of the method, apparatuses, and non-transitory computer-readable medium described herein, the counter sidelink assignment index and the total sidelink assignment index may be applicable to different priority levels, different group indices, or both.

In some examples of the method, apparatuses, and non-transitory computer-readable medium described herein, generating the one or more codebooks may include operations, features, means, or instructions for generating a first codebook that includes ACK or NACK bits corresponding to a first subset of sidelink messages from the multiple sidelink messages, the first subset of sidelink messages associated with a first priority level and generating a second codebook that includes ACK or NACK bits corresponding to a second subset of sidelink messages from the multiple sidelink messages, the second subset of sidelink messages associated with a second priority level that may be different from the first priority level.

In some examples of the method, apparatuses, and non-transitory computer-readable medium described herein, generating the one or more codebooks may include operations, features, means, or instructions for generating a first codebook that includes ACK or NACK bits corresponding to a first subset of sidelink messages from the multiple sidelink messages, the first subset of sidelink messages associated with a first group index and generating a second codebook that includes ACK or NACK bits corresponding to a second subset of sidelink messages from the multiple sidelink messages, the second subset of sidelink messages associated with a second group index that may be different from the first group index.

In some examples of the method, apparatuses, and non-transitory computer-readable medium described herein, transmitting the set of feedback messages may include operations, features, means, or instructions for transmitting, over a first PSFCH resource, a first feedback message indicating a first codebook of the one or more codebooks, the first codebook including ACK or NACK bits corresponding to a first subset of sidelink messages from the multiple sidelink messages, the first subset of sidelink messages associated with a first priority level, a first group index, or both and transmitting, over a second PSFCH resource, a second feedback message indicating a second codebook of the one or more codebooks, the second codebook including ACK or NACK bits corresponding to a second subset of sidelink messages from the multiple sidelink messages, the second subset of sidelink messages associated with a second priority level, a second group index, or both.

Some examples of the method, apparatuses, and non-transitory computer-readable medium described herein may further include operations, features, means, or instructions for receiving control signaling indicating one or more of a quantity of the one or more codebooks, a quantity of PSSCH groups, a quantity of PSSCH priority levels, a sidelink priority threshold, or an indication of whether to include ACK or NACK bits for sidelink messages associated with different priority levels, different group indices, or both in a joint codebook or in separate codebooks, where generating the one or more codebooks may be based on the control signaling.

In some examples of the method, apparatuses, and non-transitory computer-readable medium described herein, the multiple sidelink messages include unicast PSSCH transmissions.

In some examples of the method, apparatuses, and non-transitory computer-readable medium described herein, the multiple sidelink messages include unicast PSSCH transmissions, groupcast PSSCH transmissions, or both.

In some examples of the method, apparatuses, and non-transitory computer-readable medium described herein, the unicast PSSCH transmissions and the groupcast PSSCH transmissions may be associated with separate counter sidelink assignment indices and separate total sidelink assignment indices.

In some examples of the method, apparatuses, and non-transitory computer-readable medium described herein, generating the one or more codebooks may include operations, features, means, or instructions for generating a joint codebook that includes ACK or NACK bits corresponding to the unicast PSSCH transmissions and the groupcast PSSCH transmissions.

In some examples of the method, apparatuses, and non-transitory computer-readable medium described herein, generating the joint codebook may include operations, features, means, or instructions for generating a first subset of the joint codebook that includes ACK or NACK bits corresponding to the unicast PSSCH transmissions and generating a second subset of the joint codebook that includes ACK or NACK bits corresponding to the groupcast PSSCH transmissions, where the first subset of the joint codebook precedes the second subset of the joint codebook.

In some examples of the method, apparatuses, and non-transitory computer-readable medium described herein, transmitting the set of feedback messages may include operations, features, means, or instructions for transmitting an indication of the joint codebook on a PSFCH resource in accordance with the sidelink feedback configuration.

In some examples of the method, apparatuses, and non-transitory computer-readable medium described herein, transmitting the set of feedback messages may include operations, features, means, or instructions for transmitting, over a first PSFCH resource, a first feedback message indicating a first codebook of the one or more codebooks, the first codebook including ACK or NACK bits corresponding to the unicast PSSCH transmissions and transmitting, over a second PSFCH resource, a second feedback message indicating a second codebook of the one or more codebooks, the second codebook including ACK or NACK bits corresponding to the groupcast PSSCH transmissions.

Some examples of the method, apparatuses, and non-transitory computer-readable medium described herein may further include operations, features, means, or instructions for receiving radio resource control (RRC) signaling indicating whether to include ACK or NACK bits for the unicast PSSCH transmissions and ACK or NACK bits for the groupcast PSSCH transmissions in a single codebook or in different codebooks, where generating the one or more codebooks may be based on the RRC signaling.

Some examples of the method, apparatuses, and non-transitory computer-readable medium described herein may further include operations, features, means, or instructions for receiving RRC signaling indicating the sidelink feedback configuration, where transmitting the set of feedback messages to the second wireless device may be based on the RRC signaling.

In some examples of the method, apparatuses, and non-transitory computer-readable medium described herein, the multiple sidelink messages includes a first set of groupcast PSSCH transmissions associated with a first group identifier and a second set of groupcast PSSCH transmissions associated with a second group identifier.

In some examples of the method, apparatuses, and non-transitory computer-readable medium described herein, generating the one or more codebooks may include operations, features, means, or instructions for generating a joint codebook that includes acknowledgment or NACK bits corresponding to the first set of groupcast PSSCH transmissions and the second set of groupcast PSSCH transmissions.

In some examples of the method, apparatuses, and non-transitory computer-readable medium described herein, generating the joint codebook may include operations, features, means, or instructions for generating a first subset of the joint codebook that includes acknowledgment or NACK bits corresponding to the first set of groupcast PSSCH transmissions and generating a second subset of the joint codebook that includes acknowledgment or NACK bits corresponding to the second set of groupcast PSSCH transmissions.

Some examples of the method, apparatuses, and non-transitory computer-readable medium described herein may further include operations, features, means, or instructions for concatenating different subsets of the joint codebook in ascending order with respect to group identifier.

In some examples of the method, apparatuses, and non-transitory computer-readable medium described herein, generating the one or more codebooks may include operations, features, means, or instructions for generating a first codebook that includes ACK or NACK bits corresponding to the first set of groupcast PSSCH transmissions and generating a second codebook that includes ACK or NACK bits corresponding to the second set of groupcast PSSCH transmissions.

In some examples of the method, apparatuses, and non-transitory computer-readable medium described herein, transmitting the set of feedback messages may include operations, features, means, or instructions for transmitting indications of the first codebook and the second codebook on different PSFCH resources in accordance with the sidelink feedback configuration.

Some examples of the method, apparatuses, and non-transitory computer-readable medium described herein may further include operations, features, means, or instructions for receiving RRC signaling indicating whether to include acknowledgment or negative acknowledgment bits for the first set of groupcast PSSCH transmissions and acknowledgment or negative acknowledgment bits for the second set of groupcast PSSCH transmissions in a single codebook or in different codebooks, where generating the one or more codebooks may be based on the RRC signaling.

Some examples of the method, apparatuses, and non-transitory computer-readable medium described herein may further include operations, features, means, or instructions for retransmitting the set of feedback messages based on a result of a listen before talk (LBT) procedure, an unsuccessful initial transmission, or both.

Some examples of the method, apparatuses, and non-transitory computer-readable medium described herein may further include operations, features, means, or instructions for receiving SCI that indicates an ACK feedback indicator associated with the multiple sidelink messages and determining whether one or both of a counter sidelink assignment index or a total sidelink assignment index for a subsequent sidelink message may be reset based on a value of the ACK feedback indicator.

In some examples of the method, apparatuses, and non-transitory computer-readable medium described herein, generating the one or more codebooks may include operations, features, means, or instructions for generating a codebook that includes ACK or NACK bits corresponding to the multiple sidelink messages that may be associated with a same value of the ACK feedback indicator.

Some examples of the method, apparatuses, and non-transitory computer-readable medium described herein may further include operations, features, means, or instructions for receiving SCI indicating a PSSCH group index, a hybrid automatic repeat request (HARQ)-ACK trigger field, or both and determining whether to report HARQ-ACK feedback for a first PSSCH group, a second PSSCH group, or both based on the SCI.

In some examples of the method, apparatuses, and non-transitory computer-readable medium described herein, generating the one or more codebooks may include operations, features, means, or instructions for generating, based on a value of the HARQ-ACK trigger field, the one or more codebooks that include HARQ-ACK feedback for the first PSSCH group and the second PSSCH group, where the one or more codebooks may be concatenated in ascending order with respect to PSSCH group index.

Some examples of the method, apparatuses, and non-transitory computer-readable medium described herein may further include operations, features, means, or instructions for receiving SCI indicating a counter sidelink assignment index, a first total sidelink assignment index associated with a first PSSCH group, a first ACK feedback indicator associated with the first PSSCH group, or a combination thereof and determining whether one or both of the first total sidelink assignment index or the counter sidelink assignment index for the first PSSCH group may be reset based on a value of the first ACK feedback indicator.

Some examples of the method, apparatuses, and non-transitory computer-readable medium described herein may further include operations, features, means, or instructions for receiving SCI indicating a second ACK feedback indicator and a second total sidelink assignment index associated with a second PSSCH group, where generating the one or more codebooks may be based on receiving the SCI.

Some examples of the method, apparatuses, and non-transitory computer-readable medium described herein may further include operations, features, means, or instructions for receiving RRC signaling indicating a SCI format that includes a group index field, a HARQ-ACK trigger field, a first acknowledgment feedback indicator field associated with a first PSSCH group, a second ACK feedback indicator field associated with a second PSSCH group, a counter sidelink assignment index field, a first total sidelink assignment index field associated with the first PSSCH group, a second total sidelink assignment index field associated with the second PSSCH group, or a combination thereof.

A method for wireless communications at a first wireless device is described. The method may include transmitting, to a second wireless device, control signaling indicating a sidelink feedback configuration for the second wireless device, transmitting multiple sidelink messages to the second wireless device over multiple sidelink resources, and monitoring a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages.

An apparatus for wireless communications at a first wireless device is described. The apparatus may include a processor, memory coupled with the processor, and instructions stored in the memory. The instructions may be executable by the processor to cause the apparatus to transmit, to a second wireless device, control signaling indicating a sidelink feedback configuration for the second wireless device, transmit multiple sidelink messages to the second wireless device over multiple sidelink resources, and monitor a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages.

Another apparatus for wireless communications at a first wireless device is described. The apparatus may include means for transmitting, to a second wireless device, control signaling indicating a sidelink feedback configuration for the second wireless device, means for transmitting multiple sidelink messages to the second wireless device over multiple sidelink resources, and means for monitoring a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages.

A non-transitory computer-readable medium storing code for wireless communications at a first wireless device is described. The code may include instructions executable by a processor to transmit, to a second wireless device, control signaling indicating a sidelink feedback configuration for the second wireless device, transmit multiple sidelink messages to the second wireless device over multiple sidelink resources, and monitor a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages.

Some examples of the method, apparatuses, and non-transitory computer-readable medium described herein may further include operations, features, means, or instructions for receiving, from the second wireless device over a PSFCH resource, an indication of a joint codebook that includes the multiple ACK or NACK bits corresponding to the multiple sidelink messages that may be associated with different priority levels, different group indices, or both.

In some examples of the method, apparatuses, and non-transitory computer-readable medium described herein, the multiple sidelink messages may be associated with a respective multiple priority levels, a respective multiple group indices, or both and the sidelink feedback configuration indicates a sidelink priority threshold, a first mapping between the respective multiple priority levels and the one or more codebooks, a second mapping between the respective multiple group indices and the one or more codebooks, or a combination thereof.

In some examples of the method, apparatuses, and non-transitory computer-readable medium described herein, the multiple sidelink messages may be multiplexed with respective instances of SCI.

In some examples of the method, apparatuses, and non-transitory computer-readable medium described herein, each respective instance of SCI includes an indication of a counter sidelink assignment index and a total sidelink assignment index associated with a sidelink message from the multiple sidelink messages.

In some examples of the method, apparatuses, and non-transitory computer-readable medium described herein, the counter sidelink assignment index and the total sidelink assignment index may be specific to a priority level, a group index, or both.

In some examples of the method, apparatuses, and non-transitory computer-readable medium described herein, the counter sidelink assignment index and the total sidelink assignment index may be applicable to different priority levels, different group indices, or both.

Some examples of the method, apparatuses, and non-transitory computer-readable medium described herein may further include operations, features, means, or instructions for receiving, over a first PSFCH resource, a first feedback message indicating a first codebook of the one or more codebooks, the first codebook including ACK or NACK bits corresponding to a first subset of sidelink messages from the multiple sidelink messages, the first subset of sidelink messages associated with a first priority level, a first group index, or both and receiving, over a second PSFCH resource, a second feedback message indicating a second codebook of the one or more codebooks, the second codebook including ACK or NACK bits corresponding to a second subset of sidelink messages from the multiple sidelink messages, the second subset of sidelink messages associated with a second priority level, a second group index, or both.

In some examples of the method, apparatuses, and non-transitory computer-readable medium described herein, transmitting the control signaling may include operations, features, means, or instructions for transmitting RRC signaling that indicates a quantity of the one or more codebooks, a quantity of PSSCH groups, a quantity of PSSCH priority levels, a sidelink priority threshold, or a combination thereof.

In some examples of the method, apparatuses, and non-transitory computer-readable medium described herein, the multiple sidelink messages include unicast PSSCH transmissions.

In some examples of the method, apparatuses, and non-transitory computer-readable medium described herein, the multiple sidelink messages include unicast PSSCH transmissions, groupcast PSSCH transmissions, or both.

In some examples of the method, apparatuses, and non-transitory computer-readable medium described herein, the unicast PSSCH transmissions and the groupcast PSSCH transmissions may be associated with separate counter sidelink assignment indices and separate total sidelink assignment indices.

Some examples of the method, apparatuses, and non-transitory computer-readable medium described herein may further include operations, features, means, or instructions for receiving, over a PSFCH resource, a feedback message indicating a joint codebook that includes ACK or negative acknowledgment bits corresponding to the unicast PSSCH transmissions and ACK or negative acknowledgment bits corresponding to the groupcast PSSCH transmissions.

Some examples of the method, apparatuses, and non-transitory computer-readable medium described herein may further include operations, features, means, or instructions for receiving, over a first PSFCH resource, a first feedback message indicating a first codebook that includes ACK or NACK bits corresponding to the unicast PSSCH transmissions and receiving, over a second PSFCH resource, a second feedback message indicating a second codebook that includes ACK or NACK bits corresponding to the groupcast PSSCH transmissions.

In some examples of the method, apparatuses, and non-transitory computer-readable medium described herein, transmitting the control signaling may include operations, features, means, or instructions for transmitting RRC signaling that indicates whether to include ACK or NACK bits for the unicast PSSCH transmissions and ACK or NACK bits for the groupcast PSSCH transmissions in a single codebook or in different codebooks.

In some examples of the method, apparatuses, and non-transitory computer-readable medium described herein, the multiple sidelink messages includes a first set of groupcast PSSCH transmissions associated with a first group identifier and a second set of groupcast PSSCH transmissions associated with a second group identifier.

In some examples of the method, apparatuses, and non-transitory computer-readable medium described herein, transmitting the control signaling may include operations, features, means, or instructions for transmitting RRC signaling that indicates whether to include acknowledgment or negative acknowledgment bits for the first set of groupcast PSSCH transmissions and acknowledgment or negative acknowledgment bits for the second set of groupcast PSSCH transmissions in a single codebook or in different codebooks.

Some examples of the method, apparatuses, and non-transitory computer-readable medium described herein may further include operations, features, means, or instructions for receiving, over a first PSFCH resource, a first feedback message indicating a first codebook that includes ACK or NACK bits corresponding to a first set of groupcast PSSCH transmissions and receiving, over a second PSFCH resource, a second feedback message indicating a second codebook that includes ACK or NACK bits corresponding to a second set of groupcast PSSCH transmissions.

Some examples of the method, apparatuses, and non-transitory computer-readable medium described herein may further include operations, features, means, or instructions for receiving a feedback message indicating a codebook that includes ACK or NACK bits corresponding to the multiple sidelink messages that may be associated with a same acknowledgment feedback indicator value.

Some examples of the method, apparatuses, and non-transitory computer-readable medium described herein may further include operations, features, means, or instructions for transmitting SCI indicating a PSSCH group index, a HARQ-ACK trigger field, a first ACK feedback indicator associated with a first PSSCH group, a second ACK feedback indicator associated with a second PSSCH group, a counter sidelink assignment index, a first total sidelink assignment index associated with the first PSSCH group, a second total sidelink assignment index associated with the second PSSCH group, or a combination thereof.

In some examples of the method, apparatuses, and non-transitory computer-readable medium described herein, transmitting the control signaling may include operations, features, means, or instructions for transmitting RRC signaling indicating a SCI format that includes a group index field, a HARQ-ACK trigger field, a first acknowledgment feedback indicator field associated with a first PSSCH group, a second ACK feedback indicator field associated with a second PSSCH group, a counter sidelink assignment index field, a first total sidelink assignment index field associated with the first PSSCH group, a second total sidelink assignment index field associated with the second PSSCH group, or a combination thereof.

In some examples of the method, apparatuses, and non-transitory computer-readable medium described herein, transmitting the control signaling may include operations, features, means, or instructions for transmitting SCI indicating a counter sidelink assignment index, a total sidelink assignment index, an ACK feedback indicator, or a combination thereof, where a value of the ACK feedback indicator indicates whether one or both of the total sidelink assignment index or the counter sidelink assignment index may be reset for a PSSCH group.

### BRIEF DESCRIPTION OF THE DRAWINGS

FIGS. 1 and 2 illustrate examples of wireless communications systems that support techniques for enhanced sidelink feedback transmission in accordance with aspects of the present disclosure.

FIGS. 3A and 3B illustrate examples of resource mappings that supports techniques for enhanced sidelink feedback transmission in accordance with aspects of the present disclosure.

FIGS. 4A and 4B illustrate examples of resource mappings that support techniques for enhanced sidelink feedback transmission in accordance with aspects of the present disclosure.

FIGS. 5A and 5B illustrate examples of resource mappings that support techniques for enhanced sidelink feedback transmission in accordance with aspects of the present disclosure.

FIGS. 6A and 6B illustrate examples of resource mappings that support techniques for enhanced sidelink feedback transmission in accordance with aspects of the present disclosure.

FIGS. 7 and 8 illustrate examples of resource mappings that support techniques for enhanced sidelink feedback transmission in accordance with aspects of the present disclosure.

FIG. 9 illustrates an example of a process flow that supports techniques for enhanced sidelink feedback transmission in accordance with aspects of the present disclosure.

FIGS. 10 and 11 show block diagrams of devices that support techniques for enhanced sidelink feedback transmission in accordance with aspects of the present disclosure.

FIG. 12 shows a block diagram of a communications manager that supports techniques for enhanced sidelink feedback transmission in accordance with aspects of the present disclosure.

FIG. 13 shows a diagram of a system including a device that supports techniques for enhanced sidelink feedback transmission in accordance with aspects of the present disclosure.

FIGS. 14 through 17 show flowcharts illustrating methods that support techniques for enhanced sidelink feedback transmission in accordance with aspects of the present disclosure.

### DETAILED DESCRIPTION

In some wireless communications systems that support sidelink communications between wireless devices, a first wireless device (e.g., a user equipment (UE), a sidelink device) may transmit a sidelink message to a second wireless device on physical sidelink shared channel (PSSCH) resources. The second wireless device (e.g., the destination device) may transmit hybrid automatic repeat request (HARQ) acknowledgement (ACK) feedback for the sidelink message to the first wireless device (e.g., the source device) on physical sidelink feedback channel (PSFCH) resources. The HARQ-ACK feedback may include an ACK bit or a negative acknowledgement (NACK) bit corresponding to the sidelink message. The second wireless device may determine which PSFCH resources to use for transmission of the HARQ-ACK feedback based on an identifier of the first wireless device, an identifier of the second wireless device, a mapping between PSSCH resources and PSFCH resources, or a combination thereof.

In some cases, however, the second wireless device may be unable to transmit more than one bit (e.g., an ACK bit or a NACK bit) per PSFCH resource. Thus, if the second wireless device receives multiple sidelink messages from the first wireless device, the second wireless device may transmit HARQ-ACK feedback for a first sidelink message on a first PSFCH resource, and may transmit HARQ-ACK feedback for a second sidelink message on a second PSFCH resource. Transmitting one bit per PSFCH resource may result in lower signaling overhead and greater power consumption at the second wireless device. Moreover, transmitting one bit per PSFCH resource may result in greater sidelink feedback reporting latency (e.g., if there is a delay between the first PSFCH resource and the second PSFCH resource) and lower attainable throughput.

Aspects of the present disclosure provide for transmitting multiple ACK or NACK bits on a single PSFCH resource. The techniques described herein may improve the latency and signaling efficiency of sidelink feedback reporting. As an example, the second wireless device may record ACK or NACK bits for multiple sidelink messages in a type-2 HARQ-ACK codebook, and may transmit an indication of the codebook on a single PSFCH resource. Each sidelink message that the second wireless device receives (e.g., from the first wireless device) may be associated with a priority level, a group index, or both.

If the second wireless device receives sidelink messages with different priority levels, the second wireless device may generate the codebook such that ACK or NACK bits corresponding to higher priority sidelink messages precede ACK or NACK bits corresponding to lower priority sidelink messages (or vice versa). Alternatively, the second wireless device may generate different type-2 HARQ-ACK codebooks for different priority levels or groups. For example, the second wireless device may record ACK or NACK bits for sidelink messages associated with a first group index in a first codebook, and may record ACK or NACK bits for sidelink messages associated with a second group index in a second codebook. The second wireless device may then transmit the first codebook on a first PSFCH resource, and may transmit the second codebook on a second PSFCH resource.

The second wireless device may determine whether to include ACK or NACK bits for sidelink messages with different group indices or different priority levels in separate codebooks or in a joint codebook based on receiving control signaling, such as sidelink control information (SCI) or radio resource control (RRC) signaling, from the first wireless device or another network entity (e.g., a base station). This control signaling may indicate one or more total sidelink assignment indices, one or more counter sidelink assignment indices, one or more ACK feedback indicators, one or more HARQ-ACK trigger fields, or a combination thereof. The techniques described herein may enable the second wireless device to transmit sidelink feedback information with higher throughput, greater signaling efficiency, and reduced latency, among other benefits.

Aspects of the disclosure are initially described in the context of wireless communications systems, resource mappings, and process flows. Aspects of the disclosure are further illustrated by and described with reference to apparatus diagrams, system diagrams, and flowcharts that relate to techniques for enhanced sidelink feedback transmission.

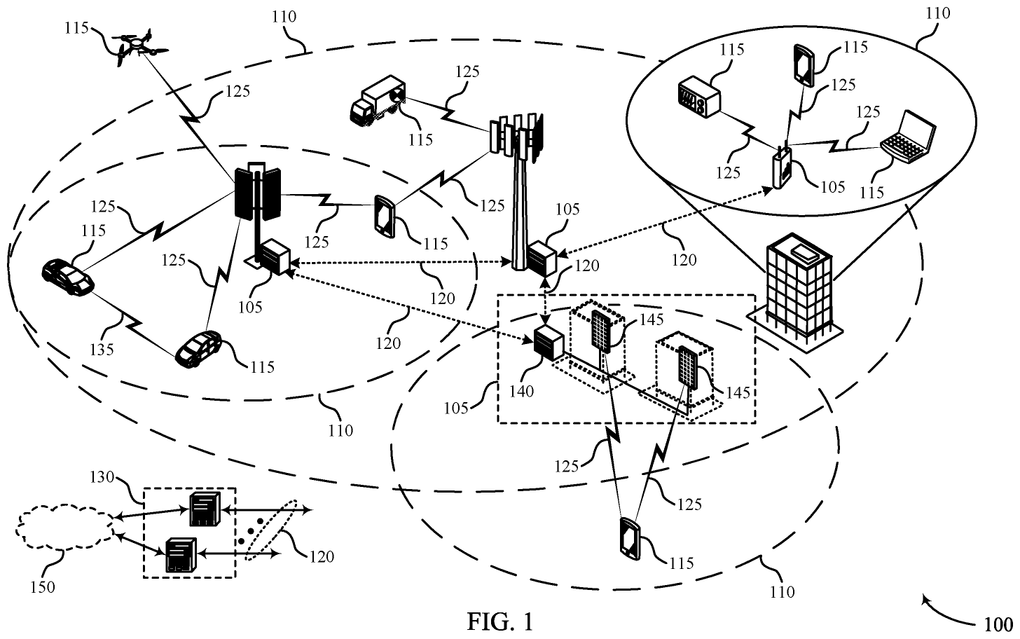

FIG. 1 illustrates an example of a wireless communications system 100 that supports techniques for enhanced sidelink feedback transmission in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Af) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RB)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems, for physical sidelink control channel (PSCCH) or PSSCH transmission, ACK or NACK feedback can be requested in PSFCH. PSFCH resources may be from a resource pool, which may or may not be a part of a dedicated PSFCH resource pool. A wireless device may be configured with a PSFCH resource periodicity (e.g., periodPSFCHresource) that refers a period (in slots) for PSFCH transmission in a resource pool. The supported periods may include 0 slots (e.g., no PSFCH transmission), 1 slot, 2 slots, or 4 slots, among other examples. PSFCH transmission may be performed in the first slot with available PSFCH resources after PSSCH transmission and after a minimum gap time after PSSCH (e.g., MinTimeGapPSFCH). A wireless device may also be configured with a set of resources (e.g., M_{PRB,set}^{PSFCH}, indicated by rbSetPSFCH) defined as a set of physical RBs (PRB) for PSFCH in a slot. This set may be split between a number of PSSCH slots corresponding to the PSFCH slot (e.g., N_{PSSCH}^{PSFCH}) and a number of PSSCH subchannels in a slot (e.g., N_{subch}). In other words, each subchannel or slot has a number of PSFCH resources PSFCH

$$( e . g . , {M}_{s u b ch , slot}^{P S F C H} = \frac{{M}_{PRB , set}^{PSFCH}}{{N}_{PSSCH}^{PSFCH} \times {N}_{subch}} PRBs )$$

indicated by a time-based mapping from PSSCH resources to PSFCH PRBs.

A PSFCH resource pool may have a size defined by the equation R_{PRB,CS}^{PSFCH}=N_{type}^{PSFCH}×N_{CS}^{PSFCH}×M_{subch,slot}^{PSFCH}, where N_{CS}^{PSFCH} is the number of cyclic shift pairs (for one ACK or NACK bit) configured per resource pool, and N_{type}^{PSFCH} is 1 or N_{subch}^{PSSCH}. For the subchannels in a PSSCH slot, the PSFCH resource pool may or may not be shared. Within the resource pool, a PSFCH resource may be indexed by PRB index, and then by cyclic shift pair index.

A wireless device may identify suitable PSFCH resources for sidelink feedback transmission according to the equation (P_{ID}+M_{ID})mod R_{PRB,CS}^{PSFCH}, where P_{ID} is a physical source identifier from SCI 2-A or 2-B for PSSCH, and MID is 0 or an identifier of the wireless device receiving the PSSCH. For unicast or NACK-based transmission, M_{ID}=0 and the wireless device may send ACK or NACK feedback at a source identifier-dependent resource within the pool. For groupcast, each receiver device may select one resource from the resource pool and transmit ACK or NACK feedback on the selected resource.

Some wireless devices may not support transmission of multiple ACK or NACK bits per PSFCH resource. A PSFCH resource may refer to one RB in one symbol with a format that is similar to physical uplink control channel (PUCCH) format 0. The PSFCH resource may carry 1 bit. If a wireless device is scheduled to send multiple ACK or NACK bits, the wireless device may FDM these bits on multiple PSFCH resources. This transmission technique may be applicable if, for example, a wireless device receives multiple PSSCH from the same source device. In such cases, the PSSCHs may be mapped to PSFCH resources that are hashed to the same PSFCH location (e.g., when a PSFCH period is 2 or 4 slots). This transmission technique may also apply to the case where a wireless device receives multiple PSSCH from different source devices and is scheduled to send PSFCH to each source device. In such cases, there may be a limit to how many PSFCH resources a wireless device can multiplex in the same symbol.

Introducing multi-bit PSFCH transmissions may be desirable for many scenarios, such as sidelink eMBB, where there may be a higher likelihood of a continuous PSSCH stream being transmitted to the same destination node. Multi-bit PSFCH transmission may also be applicable to sidelink carrier aggregation, which may increase the number of ACK or NACK bits that can be transmitted at a given time. Additionally, for sidelink applications in unlicensed radio frequency spectrum bands, wireless devices may be unable to configure frequent PSFCH opportunities (e.g., possible PSFCH transmissions may have a periodicity that is larger than 4 slots). Using conventional techniques to transmit multiple ACK or NACK bits may involve multiplexing many PSFCH resources. By introducing multi-bit PSFCH, wireless devices can reduce the number of PSFCH resources that are multiplexed at a given time. For multiple ACK or NACK bits to the same source UE, the techniques described herein may utilize a Uu uplink design in which ACK or NACK bits are collected into a codebook and transmitted on a single channel.

For sidelink applications other than V2X, supporting transmission of multiple ACK or NACK bits from one destination UE to the same source UE may result in higher throughput and greater signaling efficiency. The multiple ACK or NACK bits may correspond to multiple PSSCHs from the same node. The multiple ACK or NACK bits may also correspond to previously failed ACK or NACK transmissions (e.g., due to listen before talk (LBT) failure in unlicensed bands) that are scheduled to be retransmitted from the destination node. To support the techniques described herein, a sidelink HARQ-ACK codebook may be used to convey multiple ACK or NACK bits from a destination device to a source. The techniques described herein provide for extending type-2 HARQ-ACK codebook usage to sidelink applications. The described techniques also support enhanced type-2 HARQ-ACK codebooks for sidelink operations in unlicensed bands.

The wireless communications system 100 may support techniques for improved sidelink feedback transmission at a wireless device. For example, the techniques and operations described with reference to FIG. 1 may enable a wireless device (e.g., a destination UE) to transmit multiple ACK or NACK bits (e.g., corresponding to multiple PSSCH transmissions from a source UE) on a single PSFCH resource, as opposed to transmitting a single ACK or NACK bit per PSFCH resource. As a result, the wireless device may experience higher throughput and greater signaling efficiency, among other benefits.

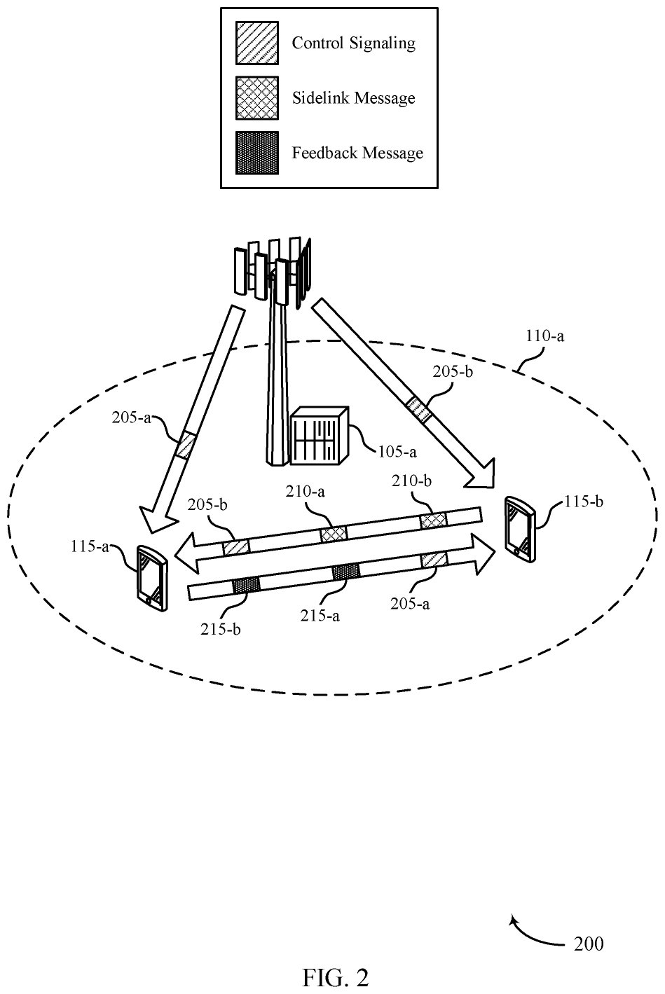

FIG. 2 illustrates an example of a wireless communications system 200 that supports techniques for enhanced sidelink feedback transmission in accordance with aspects of the present disclosure. The wireless communications system 200 may implement or be implemented by aspects of the wireless communications system 100. For example, the wireless communications system 200 may include a UE 115-a, a UE 115-b, and a base station 105-a, which may be examples of corresponding devices described with reference to FIG. 1. The UEs 115 and the base station 105-a may communicate within a geographic coverage area 110-a, which may be an example of a geographic coverage area 110 described with reference to FIG. 1. In the wireless communications system 200, the UE 115-a may generate one or more sidelink type-2 HARQ-ACK codebooks that include ACK or NACK bits corresponding to sidelink messages 210.

The wireless communications system 200 may support sidelink communications between the UE 115-a (e.g., a destination UE) and the UE 115-b (e.g., a source UE). For example, the UE 115-b may transmit sidelink messages 210 to the UE 115-a over PSSCH resources, and the UE 115-a may transmit feedback messages 215 to the UE 115-a over PSFCH resources. The feedback messages 215 may include HARQ-ACK feedback (e.g., ACK or NACK bits) corresponding to the sidelink messages 210. To support transmission of the feedback messages 215 on PSFCH resources, the base station 105-a may transmit control signaling 205-a to the UE 115-a. Similarly, the base station 105-a may transmit control signaling 205-b to the UE 115-b. In some examples, the UE 115-a may relay the control signaling 205-a to the UE 115-b in accordance with a sidelink communication scheme. Likewise, the UE 115-b may relay the control signaling 205-b to the UE 115-a in accordance with a sidelink communication scheme.

In some examples, the control signaling 205 may include RRC signaling that indicates a minimum PSFCH gap time (e.g., a minimum time duration between PSSCH transmission and PSFCH transmission), a PSFCH periodicity (e.g., a number of slots between PSFCH resources), a mapping between PSSCH resources and PSFCH resources, a PSFCH resource pool configuration, an algorithm for identifying PSFCH resources based on identifiers of the UEs 115, or a combination thereof. The control signaling 205 may also indicate a sidelink feedback configuration, which the UE 115-a may use for sidelink type-2 HARQ-ACK codebook generation. For example, the control signaling 205 may indicate whether to include ACK or NACK bits for sidelink messages associated with different priority levels (e.g., PSSCH priority levels) or groups (e.g., unicast PSSCH groups, groupcast PSSCH groups) in a joint type-2 HARQ-ACK codebook or in separate type-2 HARQ-ACK codebooks. Additionally or alternatively, the control signaling 205 may indicate whether counter sidelink assignment indices and total assignment indices are jointly counted or separately counted for different priority levels or groups.

The UE 115-b may transmit a sidelink message 210-a to the UE 115-a on a first PSSCH resource, and may transmit a sidelink message 210-b to the UE 115-a on a second PSSCH resource. In some examples, the sidelink messages 210 may be multiplexed with respective PSCCH transmissions that include SCI related to the sidelink messages 210. For example, the SCI (e.g., piggyback SCI) may indicate one or more of a total sidelink assignment index, a counter sidelink assignment index, an ACK feedback indicator, a group index, a priority level, or a HARQ-ACK feedback trigger for the sidelink messages 210. In some examples, the UE 115-a may determine whether to reset the total sidelink assignment index and the counter sidelink assignment index for the sidelink messages based on a value of the ACK feedback indicator. Similarly, the UE 115-a may determine whether to transmit HARQ-ACK feedback for the sidelink messages 210 based on a value of the HARQ-ACK feedback trigger.

The UE 115-a may generate HARQ-ACK feedback for the sidelink messages 210 based on the control signaling 205 and the SCI from the PSCCH transmissions multiplexed with the sidelink messages 210. For example, the UE 115-a may determine (e.g., based on the SCI) that the sidelink message 210-a is associated with a first priority level, a first group (e.g., a unicast PSSCH group or a groupcast PSSCH group), or both. Similarly, the UE 115-a may determine that the sidelink message 210-b is associated with a second priority level, a second group index, or both. Accordingly, the UE 115-a may determine (e.g., based on the control signaling 205) whether to include ACK or NACK bits for the sidelink messages 210 in the same codebook or in different codebooks.

If, for example, the UE 115-a generates separate type-2 HARQ-ACK codebooks for the sidelink messages 210, the UE 115-a may transmit indications of the type-2 HARQ-ACK codebooks on separate PSFCH resources. For example, the UE 115-a may transmit a feedback message 215-a to the UE 115-b on a first PSFCH resource, and may transmit a feedback message 215-b to the UE 115-b on a second PSFCH resource. The feedback message 215-a may include an indication of a first codebook that includes an ACK or NACK bit corresponding to the sidelink message 210-a, while the feedback message 215-b may include an indication of a second codebook that includes an ACK or NACK bit corresponding to the sidelink message 210-b. Alternatively, the UE 115-a may generate a joint codebook that includes ACK or NACK bits for both of the sidelink messages 210. In such examples, the UE 115-a may transmit an indication of the joint codebook on a single PSFCH resource.

The wireless communications system 200 may support techniques for improved sidelink feedback transmission at the UE 115-a. For example, the techniques and operations described with reference to FIG. 2 may enable the UE 115-a (e.g., a destination UE) to transmit multiple ACK or NACK bits (e.g., corresponding to the sidelink messages 210 from the UE 115-b) on a single PSFCH resource, as opposed to transmitting a single ACK or NACK bit per PSFCH resource. As a result, the UE 115-a may experience higher throughput and greater signaling efficiency, among other benefits.

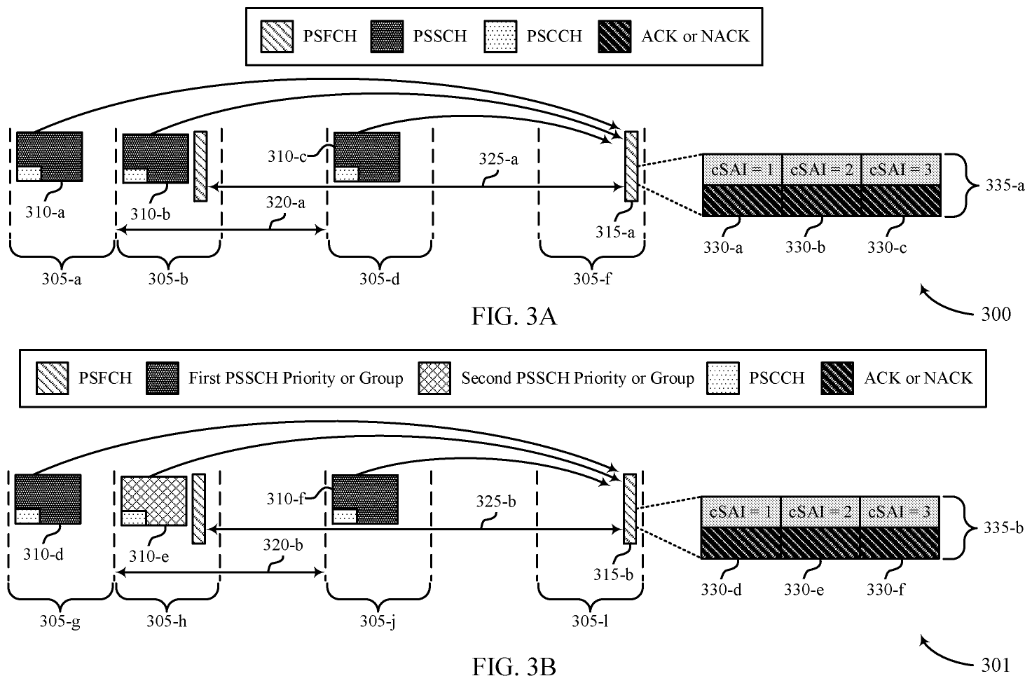

FIGS. 3A and 3B illustrate examples of a resource mapping 300 and a resource mapping 301 that support techniques for enhanced sidelink feedback transmission in accordance with aspects of the present disclosure. The resource mapping 300 and the resource mapping 301 may implement or be implemented by aspects of the wireless communications system 100 or the wireless communications system 200. For example, the resource mapping 300 and the resource mapping 301 may implement or be implemented by a wireless device, which may be an example of a UE 115 described with reference to FIGS. 1 and 2. In accordance with the resource mapping 300 and the resource mapping 301, a wireless device (e.g., a destination UE) may transmit an indication of a sidelink type-2 HARQ-ACK codebook that includes ACK or NACK bits corresponding to sidelink messages with different priority levels or group indices.

In the example of FIG. 3A, a first wireless device (e.g., a source UE) may transmit multiple PSSCH transmissions 310 (e.g., sidelink messages) to a second wireless device (e.g., a destination UE). For example, the first wireless device may transmit a PSSCH transmission 310-a to the second wireless device during a slot 305-a, and may transmit a PSSCH transmission 310-b to the second wireless device during a slot 305-b. The first wireless device may also transmit a PSSCH transmission 310-c to the second wireless device during a slot 305-d. Each of the PSSCH transmissions 310 may be multiplexed with a corresponding PSCCH transmission, which may include SCI related to the PSSCH transmissions 310. Each instance of SCI may indicate a total sidelink assignment index and a counter sidelink assignment index for a respective sidelink message.

After monitoring for the PSSCH transmissions 310 from the first wireless device, the second wireless device may generate a codebook 335-a (e.g., a type-2 HARQ-ACK codebook for sidelink messages) that includes ACK or NACK bits corresponding to the PSSCH transmissions 310. For example, the codebook 335-a may include an ACK or NACK bit 330-a corresponding to the PSSCH transmission 310-a, an ACK or NACK bit 330-b corresponding to the PSSCH transmission 310-b, and an ACK or NACK bit 330-c corresponding to the PSSCH transmission 310-c. As illustrated in FIG. 3A, the PSSCH transmission 310-a may be associated with a counter sidelink assignment index of 1, the PSSCH transmission 310-b may be associated with a counter sidelink assignment index of 2, and the PSSCH transmission 310-c may be associated with a counter sidelink assignment index of 3.

The second wireless device may transmit an indication of the codebook 335-a in accordance with a sidelink feedback configuration, which may include a PSFCH periodicity 325-a and a minimum PSFCH gap time 320-a. The PSFCH periodicity 325-a may refer to a number of slots 305 between PSFCH resources 315, while the minimum PSFCH gap time 320-a may refer to a minimum number of slots between when the second wireless device receives a sidelink message and when the second wireless device can transmit feedback (e.g., HARQ-ACK feedback) for the sidelink message. For example, if the second wireless device successfully receives the PSSCH transmission 310-b in the slot 305-b and the minimum PSFCH gap time 320-a is 2 slots, the second wireless device may be unable to transmit HARQ-ACK feedback (e.g., an ACK bit) for the PSSCH transmission 310-b until the minimum PSFCH gap time 320-a has elapsed (e.g., from the slot 305-d). In other words, the second wireless device may transmit HARQ-ACK feedback for the PSSCH transmission 310-b in the first slot that includes PSFCH resources and is at least 2 slots after the last slot in which the second wireless device receives the PSSCH transmission 310-b. In accordance with this sidelink feedback configuration, the second wireless device may transmit an indication of the codebook 335-a to the first wireless device on PSFCH resources 315-a located in a slot 305-f.

In the example of FIG. 3B, a first wireless device (e.g., a source UE) may transmit multiple PSSCH transmissions 310 (e.g., sidelink messages) to a second wireless device (e.g., a destination UE). For example, the first wireless device may transmit a PSSCH transmission 310-d to the second wireless device during a slot 305-g, and may transmit a PSSCH transmission 310-e to the second wireless device during a slot 305-h. The first wireless device may also transmit a PSSCH transmission 310-f to the second wireless device during a slot 305-j. Each of the PSSCH transmissions 310 may be multiplexed with a corresponding PSCCH transmission, which may include SCI related to the PSSCH transmissions 310. Each instance of SCI may indicate a total sidelink assignment index and a counter sidelink assignment index for a respective sidelink message.

The PSSCH transmissions 310 may be associated with different PSSCH priority levels or PSSCH groups (e.g., unicast or groupcast). For example, the PSSCH transmission 310-d and the PSSCH transmission 310-f may be associated with a first PSSCH priority level or group, while the PSSCH transmission 310-e may be associated with a second PSSCH priority level or group. In some examples, total sidelink assignment indices and counter sidelink assignment indices may be counted separately for different PSSCH priority levels or PSSCH groups. Alternatively (e.g., as illustrated in the example of FIG. 3B), the total sidelink assignment indices and counter sidelink assignment indices may be jointly counted for different PSSCH priority levels or PSSCH groups.

After monitoring for the PSSCH transmissions 310 from the first wireless device, the second wireless device may generate a codebook 335-b (e.g., a type-2 HARQ-ACK codebook for sidelink communications) that includes ACK or NACK bits corresponding to the PSSCH transmissions 310. For example, the codebook 335-b may include an ACK or NACK bit 330-d corresponding to the PSSCH transmission 310-d, an ACK or NACK bit 330-e corresponding to the PSSCH transmission 310-e, and an ACK or NACK bit 330-f corresponding to the PSSCH transmission 310-f. As illustrated in FIG. 3B, the PSSCH transmission 310-d may be associated with a counter sidelink assignment index of 1, the PSSCH transmission 310-e may be associated with a counter sidelink assignment index of 2, and the PSSCH transmission 310-f may be associated with a counter sidelink assignment index of 3.

The second wireless device may transmit an indication of the codebook 335-b in accordance with a sidelink feedback configuration, which may include a PSFCH periodicity 325-b and a minimum PSFCH gap time 320-b. The PSFCH periodicity 325-b may refer to a number of slots 305 between PSFCH resources 315, while the minimum PSFCH gap time 320-b may refer to a minimum number of slots between when the second wireless device receives a sidelink message and when the second wireless device can transmit feedback (e.g., HARQ-ACK feedback) for the sidelink message. For example, if the second wireless device unsuccessfully receives the PSSCH transmission 310-e in the slot 305-h and the minimum PSFCH gap time 320-b is 2 slots, the second wireless device may be unable to transmit HARQ-ACK feedback (e.g., a NACK bit) for the PSSCH transmission 310-e until the minimum PSFCH gap time 320-b has elapsed (e.g., from the slot 305-j). In other words, the second wireless device may transmit HARQ-ACK feedback for the PSSCH transmission 310-e in the first slot that includes PSFCH resources and is at least 2 slots after the last slot in which the second wireless device receives the PSSCH transmission 310-e. In accordance with this sidelink feedback configuration, the second wireless device may transmit an indication of the codebook 335-b to the first wireless device on PSFCH resources 315-b located in a slot 305-1.

The resource mapping 300 and the resource mapping 301 may support techniques for improved sidelink feedback transmission at a wireless device. For example, the techniques and operations described with reference to FIGS. 3A and 3B may enable a wireless device (e.g., a destination UE) to transmit multiple ACK or NACK bits (e.g., corresponding to multiple PSSCH transmissions from a source UE) on a single PSFCH resource, as opposed to transmitting a single ACK or NACK bit per PSFCH resource. As a result, the wireless device may experience higher throughput and greater signaling efficiency, among other benefits.

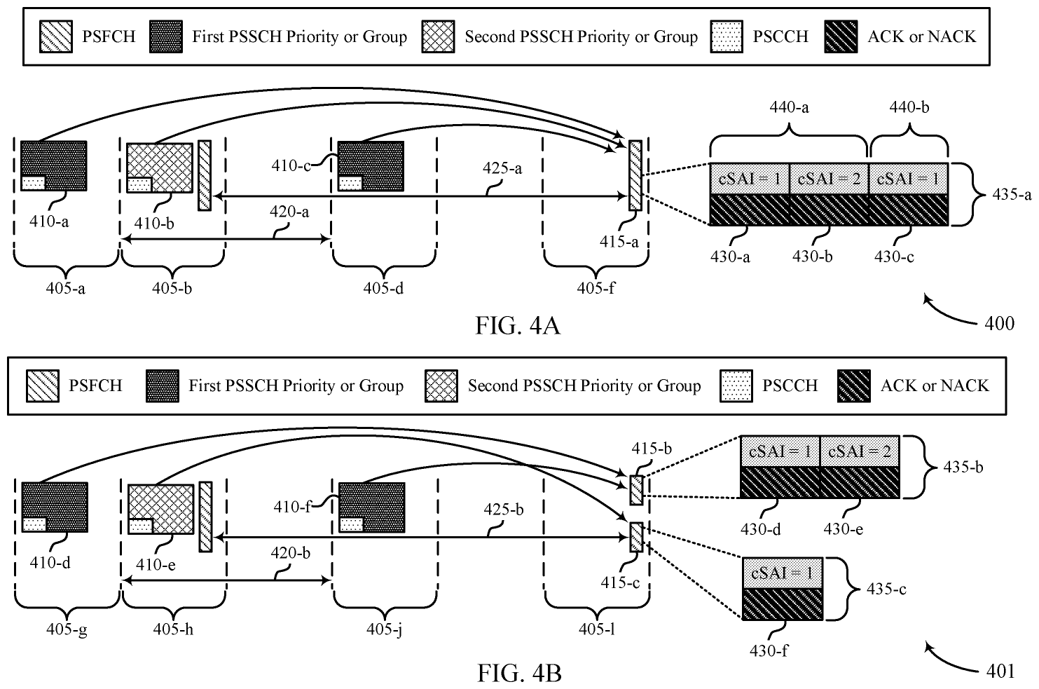

FIGS. 4A and 4B illustrate examples of a resource mapping 400 and a resource mapping 401 that support techniques for enhanced sidelink feedback transmission in accordance with aspects of the present disclosure. The resource mapping 400 and the resource mapping 401 may implement or be implemented by aspects of the wireless communications system 100 or the wireless communications system 200. For example, the resource mapping 400 and the resource mapping 401 may implement or be implemented by a wireless device, which may be an example of a UE 115 described with reference to FIGS. 1 and 2. In accordance with the resource mapping 400, a wireless device (e.g., a destination UE) may generate a joint type-2 HARQ-ACK codebook that includes ACK or NACK bits corresponding to sidelink messages (e.g., PSSCH transmissions) associated with different priority levels or groups (e.g., unicast PSSCH groups, groupcast PSSCH groups). In accordance with the resource mapping 401, a wireless device may generate separate type-2 HARQ-ACK codebooks that include ACK or NACK bits corresponding to sidelink messages associated with a specific priority level or group index.

The resource mapping 400 and the resource mapping 401 may support type-2 HARQ-ACK codebooks for unicast PSSCH transmissions. For example, the described techniques may support transmission of a joint or mixed type-2 HARQ-ACK codebook for PSSCHs with different priorities. In some examples, a counter sidelink assignment index and a total sidelink assignment index in SCI (e.g., SCI1 or SCI2A) may be jointly counted for PSSCHs with different priorities. In other examples, counter sidelink assignment indices and total sidelink assignment indices in SCI (e.g., SCI1 or SCI2A) may be separately counted for different priorities. Type-2 sub-codebooks for each PSSCH priority may be concatenated in ascending order or descending order with respect to PSSCH priority. In other examples, PSSCHs with different priorities may be separated into multiple groups. Counter sidelink assignment indices and total sidelink assignment indices in SCI (e.g., SCI1 or SCI2) may be separately counted for PSSCHs associated with different groups. Type-2 sub-codebooks for each group may be concatenated in ascending or descending order with respect to group index.

In some examples, these PSSCH groups can be hardcoded or configured via RRC signaling. Additionally or alternatively, PSSCH group index may be determined based on PSSCH priority level. For example, if there are M groups defined or configured, priority 0 to priority (8/M−1) may belong to the first group, and priority (8/M) to priority (8*2 M−1) may belong to the second group. If M is 8 and there are two separate PSSCH groups, group index 0 may correspond to priority levels 0-3, and group index 1 may correspond to priority levels 4-7. In other examples, a wireless device may use sidelink priority thresholds (e.g., sl-PriorityThreshold or sl-PriorityThreshold-UL-URLLC) to determine a suitable group for a PSSCH transmission. If a priority level of a PSSCH transmission is less than these thresholds, the PSSCH may be associated with the first group. Otherwise, the priority level may be associated with the second group. For example, group index 0 may correspond to PSSCH priority levels that are below sl-PriorityThreshold or sl-PriorityThreshold-UL-URLLC, and group index 1 may correspond to PSSCH priority levels that are above sl-PriorityThreshold or sl-PriorityThreshold-UL-URLLC.

The resource mapping 400 and the resource mapping 401 may also support separate type-2 HARQ-ACK codebooks for PSSCH transmissions with different priorities. For example, a counter sidelink assignment index and a total sidelink assignment index in SCI (e.g., SCI1 or SCI2A) may be jointly counted for PSSCH transmissions with corresponding HARQ-ACK bits transmitted in a common HARQ-ACK codebook. Alternatively, counter sidelink assignment indices and total sidelink assignment indices in SCI (e.g., SCI1 or SCI2A) may be separately counted for PSSCH transmissions with corresponding HARQ-ACK bits transmitted in different HARQ-ACK codebooks.

In some examples, the number of separate HARQ-ACK codebooks for PSSCH transmissions with different priorities can be hardcoded or configured via RRC signaling. For example, a HARQ-ACK codebook index of 0 may correspond to priority levels 0-3, and a HARQ-ACK codebook index of 1 may correspond to priority levels 4-7 (e.g., assuming 2 separate codebooks and 8 different priority levels). Additionally or alternatively, a wireless device may use various sidelink priority thresholds (e.g., sl-PriorityThreshold or sl-PriorityThreshold-UL-URLLC) to determine the number of HARQ-ACK codebooks in which to report ACK or NACK bits for PSSCH transmissions. For PSSCH transmissions associated with priority levels that are below these thresholds, one HARQ-ACK codebook may be generated and transmitted on a single PSFCH resource. For PSSCH transmissions associated with priority levels greater than or equal to these thresholds, another HARQ-ACK codebook may be generated and transmitted on a different PSFCH resource. For example, a HARQ-ACK codebook index of 0 may correspond to priority levels that are below sl-PriorityThreshold or sl-PriorityThreshold-UL-URLLC, and a HARQ-ACK codebook index of 1 may correspond to priority levels above sl-PriorityThreshold or sl-PriorityThreshold-UL-URLLC. An indication of whether to use joint or separate type-2 HARQ-ACK codebooks for PSSCH transmissions with different priorities can be configured via RRC signaling.

In the example of FIG. 4A, a first wireless device (e.g., a destination UE) may generate a joint codebook 435-a (e.g., a type-2 HARQ-ACK codebook for sidelink communications) that includes ACK or NACK bits 430 corresponding to PSSCH transmissions 410 that are associated with different PSSCH priority levels or groups. As an example, a second wireless device (e.g., a source UE) may transmit a PSSCH transmission 410-a to the first wireless device during a slot 405-a, and may transmit a PSSCH transmission 410-b to the first wireless device during a slot 405-b. The second wireless device may also transmit a PSSCH transmission 410-c to the first wireless device during a slot 405-d. The PSSCH transmission 410-a and the PSSCH transmission 410-c may be associated with a first PSSCH priority level or group, while the PSSCH transmission 410-b may be associated with a second PSCCH priority level or group. Each of the PSSCH transmissions 410 may be multiplexed with a corresponding PSCCH transmission that includes SCI related to one of the PSSCH transmissions 410. Each instance of SCI may indicate a counter sidelink assignment index and a total sidelink assignment index for a respective PSSCH transmission (e.g., sidelink message).

As illustrated in the example of FIG. 4A, total sidelink assignment indices and counter sidelink assignment indices may be counted separately for different PSSCH priority levels or groups. For example, both the PSSCH transmission 410-a and the PSSCH transmission 410-b may be associated with a total sidelink assignment index of 1 and a counter sidelink assignment index of 1 (e.g., because these PSSCH transmissions belong to different PSSCH priority levels or groups). The PSSCH transmission 410-c may be associated with a total sidelink assignment index of 2 and a counter sidelink assignment index of 2 (e.g., because the PSSCH transmission 410-c is subsequent to the PSSCH transmission 410-a).

After monitoring for the PSSCH transmissions 410, the first wireless device may generate the joint codebook 435-a that includes ACK or NACK bits 430 corresponding to the PSSCH transmissions 410. The joint codebook 435-a may include a subset 440-a (e.g., a first sub-codebook) corresponding to the first PSSCH priority level or group and a subset 440-b (e.g., a second sub-codebook) corresponding to the second PSSCH priority level or group. The subset 440-a may include an ACK or NACK bit 430-a corresponding to the PSSCH transmission 410-a and an ACK or NACK bit 430-b corresponding to the PSSCH transmission 410-c, while the subset 440-b may include an ACK or NACK bit 430-c corresponding to the PSSCH transmission 410-b.

The first wireless device may transmit the joint codebook 435-a on PSFCH resources 415-a in accordance with a sidelink feedback configuration of the first wireless device. As described herein, this sidelink feedback configuration may include a PSFCH periodicity 425-a and a minimum PSFCH gap time 420-a. The PSFCH periodicity 425-a may refer to a number of slots 405 between PSFCH resources 415, while the minimum PSFCH gap time 420-a may refer to a minimum number of slots between when the first wireless device receives a sidelink message (e.g., a PSSCH transmission) and when the first wireless device can transmit feedback (e.g., HARQ-ACK feedback) for the sidelink message. For example, if the first wireless device successfully receives the PSSCH transmission 410-b in the slot 405-b and the minimum PSFCH gap time 420-a is 2 slots, the first wireless device may be unable to transmit HARQ-ACK feedback (e.g., an ACK bit) for the PSSCH transmission 410-b until the minimum PSFCH gap time 420-a has elapsed (e.g., from the slot 405-d). In other words, the first wireless device may transmit HARQ-ACK feedback for the PSSCH transmission 410-b in the first slot that includes PSFCH resources and is at least 2 slots after the last slot in which the first wireless device receives the PSSCH transmission 410-b. In accordance with this sidelink feedback configuration, the first wireless device may transmit an indication of the joint codebook 435-a to the second wireless device on PSFCH resources 415-a located in a slot 405-f.

In the example of FIG. 4B, a first wireless device (e.g., a destination UE) may generate a codebook 435-b and a codebook 435-c (e.g., separate type-2 HARQ-ACK codebooks) that include ACK or NACK bits 430 corresponding to PSSCH transmissions 410. Specifically, the codebook 435-b may include HARQ-ACK feedback for PSSCH transmissions 410 associated with a first PSSCH priority level or group, and the codebook 435-c may include HARQ-ACK feedback for PSSCH transmissions 410 associated with a second PSSCH priority level or group. As an example, a second wireless device (e.g., a source UE) may transmit a PSSCH transmission 410-d to the first wireless device during a slot 405-g, and may transmit a PSSCH transmission 410-e to the first wireless device during a slot 405-h. The second wireless device may also transmit a PSSCH transmission 410-f to the first wireless device during a slot 405-j. The PSSCH transmission 410-d and the PSSCH transmission 410-f may be associated with a first PSSCH priority level or group, while the PSSCH transmission 410-e may be associated with a second PSCCH priority level or group. Each of the PSSCH transmissions 410 may be multiplexed with a corresponding PSCCH transmission that includes SCI related to one of the PSSCH transmissions 410. The SCI may indicate a counter sidelink assignment index and a total sidelink assignment index for a respective PSSCH transmission (e.g., sidelink message).

As illustrated in the example of FIG. 4B, total sidelink assignment indices and counter sidelink assignment indices may be counted separately for different PSSCH priority levels or groups. For example, both the PSSCH transmission 410-d and the PSSCH transmission 410-e may be associated with a total sidelink assignment index of 1 and a counter sidelink assignment index of 1 (e.g., because these PSSCH transmissions belong to different PSSCH priority levels or groups). The PSSCH transmission 410-f may be associated with a total sidelink assignment index of 2 and a counter sidelink assignment index of 2 (e.g., because the PSSCH transmission 410-f belongs to the first PSSCH priority level or group and is subsequent to the PSSCH transmission 410-d).

After monitoring for the PSSCH transmissions 410, the first wireless device may generate the codebook 435-b and the codebook 435-c. The codebook 435-b may include an ACK or NACK bit 430-d corresponding to the PSSCH transmission 410-d and an ACK or NACK bit 430-e corresponding to the PSSCH transmission 410-f, while the codebook 435-c may include an ACK or NACK bit 430-f corresponding to the PSSCH transmission 410-e. As described herein, the first wireless device may receive an indication of whether to generate a joint codebook (as illustrated in FIG. 4A) or separate codebooks (as illustrated in FIG. 4B) via RRC signaling from the second wireless device or another network entity.

The first wireless device may transmit an indication of the codebook 435-b on PSFCH resources 415-b, and may transmit an indication of the codebook 435-c on PSFCH resources 415-c. That is, the first wireless device may transmit indications of the codebooks 435 on separate PSFCH resources 415 within a slot 405-1. The first wireless device may transmit these indications in accordance with a sidelink feedback configuration, which may include a PSFCH periodicity 425-b and a minimum PSFCH gap time 420-b. The PSFCH periodicity 425-b may refer to a number of slots 405 between PSFCH resources 415, while the minimum PSFCH gap time 420-b may refer to a minimum number of slots between when the first wireless device receives a sidelink message (e.g., a PSSCH transmission) and when the first wireless device can transmit feedback (e.g., HARQ-ACK feedback) for the sidelink message. For example, if the first wireless device unsuccessfully monitors for the PSSCH transmission 410-e in the slot 405-h and the minimum PSFCH gap time 420-b is 2 slots, the first wireless device may be unable to transmit HARQ-ACK feedback (e.g., a NACK bit) for the PSSCH transmission 410-e until the minimum PSFCH gap time 420-b has elapsed (e.g., from the slot 405-j). In other words, the first wireless device may transmit HARQ-ACK feedback for the PSSCH transmission 410-e in the first slot that includes PSFCH resources and is at least 2 slots after the last slot in which the first wireless device receives the PSSCH transmission 410-e.

The resource mapping 400 and the resource mapping 401 may support techniques for improved sidelink feedback transmission at a wireless device. For example, the techniques and operations described with reference to FIGS. 4A and 4B may enable a wireless device (e.g., a destination UE) to transmit multiple ACK or NACK bits (e.g., corresponding to multiple PSSCH transmissions from a source UE) on a single PSFCH resource, as opposed to transmitting a single ACK or NACK bit per PSFCH resource. As a result, the wireless device may experience higher throughput and greater signaling efficiency, among other benefits.

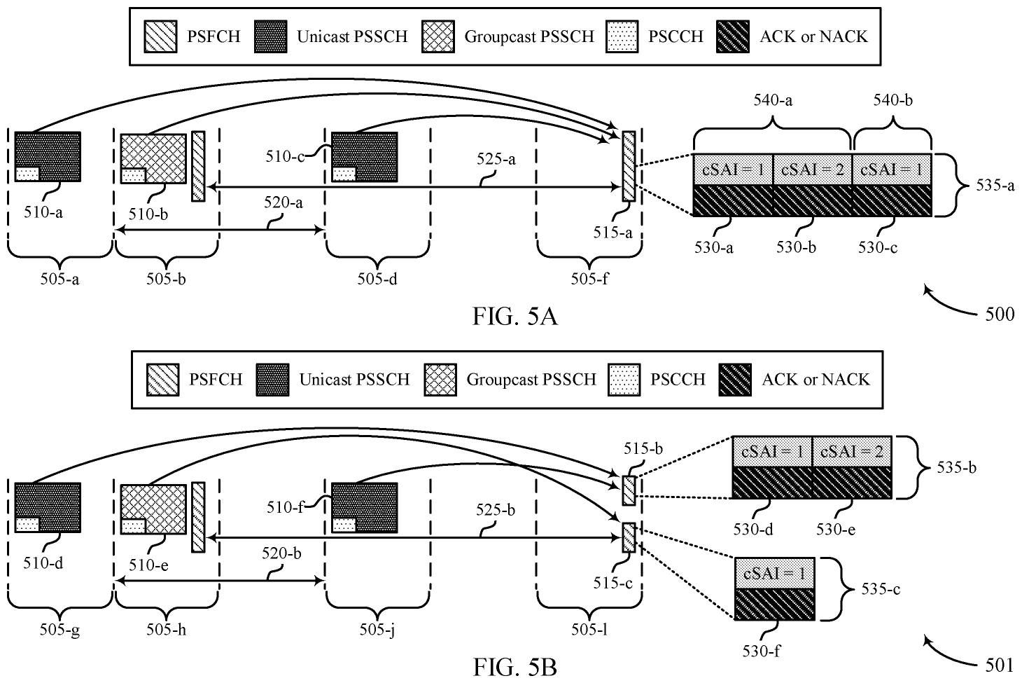

FIGS. 5A and 5B illustrate examples of a resource mapping 500 and a resource mapping 501 that support techniques for enhanced sidelink feedback transmission in accordance with aspects of the present disclosure. The resource mapping 500 and the resource mapping 501 may implement or be implemented by aspects of the wireless communications system 100 or the wireless communications system 200. For example, the resource mapping 500 and the resource mapping 501 may implement or be implemented by a wireless device, which may be an example of a UE 115 described with reference to FIGS. 1 and 2. In accordance with the resource mapping 500, a wireless device (e.g., a destination UE) may generate a joint type-2 HARQ-ACK codebook that includes ACK or NACK bits corresponding to sidelink messages (e.g., PSSCH transmissions) associated with different priority levels or groups (e.g., unicast PSSCH groups, groupcast PSSCH groups). In accordance with the resource mapping 501, a wireless device may generate separate type-2 HARQ-ACK codebooks that include ACK or NACK bits corresponding to sidelink messages associated with a specific priority level or group index (e.g., unicast PSSCH groups, groupcast PSSCH groups).

The resource mapping 500 and the resource mapping 501 may support type-2 HARQ-ACK codebooks for both unicast and groupcast PSSCH transmissions with HARQ operations when HARQ-ACK information includes ACK or NACK bits. In some examples, counter sidelink assignment indices and total sidelink assignment indices may be counted separately for unicast and groupcast PSSCH transmissions. Type-2 HARQ-ACK codebooks for unicast and groupcast PSSCH transmissions can also be concatenated and multiplexed on the same PSFCH resource. In some examples, a type-2 HARQ-ACK codebook for unicast PSSCH transmissions may precede a type-2 HARQ-ACK codebook for groupcast PSSCH transmissions.

Type-2 HARQ-ACK codebooks for unicast PSSCH transmissions and groupcast PSSCH transmissions may also be transmitted separately (e.g., on corresponding PSFCH resources). An indication of whether type-2 HARQ-ACK codebooks for unicast and groupcast PSSCH transmissions are to be jointly transmitted or separately transmitted may be configured via RRC signaling. The described techniques may be applicable to cases where groupcast UEs are fixed (e.g., for PLCs, sensors, actuators).

The resource mapping 500 and the resource mapping 501 may also support type-2 HARQ-ACK codebooks for multiple PSSCH groupcast groups. In such examples, counter sidelink assignment indices and total sidelink assignment indices may be separately counted per groupcast PSSCH group. As an example, a wireless device may generate a joint type-2 codebook by concatenating a type-2 sub-codebook for each PSSCH groupcast group in ascending order with respect to group index. Alternatively, a wireless device may generate a type-2 codebook separately for each groupcast PSSCH group, and may transmit these separate codebooks on separate PSFCH resources. A wireless device may receive RRC signaling from a network entity or another wireless device that indicates whether to generate joint or separate type-2 codebooks for different groupcast PSSCH groups. The techniques described herein may be applicable to cases where one transmitting device has multiple groups of groupcast PSSCH transmissions to the same receiving device.

In the example of FIG. 5A, a first wireless device (e.g., a destination UE) may generate a joint codebook 535-a (e.g., a type-2 HARQ-ACK codebook for sidelink communications) that includes ACK or NACK bits 530 corresponding to unicast and groupcast PSSCH transmissions. As an example, a second wireless device (e.g., a source UE) may transmit a PSSCH transmission 510-a to the first wireless device during a slot 505-a, and may transmit a PSSCH transmission 510-b to the first wireless device during a slot 505-b. The second wireless device may also transmit a PSSCH transmission 510-c to the first wireless device during a slot 505-d. The PSSCH transmission 510-a and the PSSCH transmission 510-c may be examples of unicast PSSCH transmissions, while the PSSCH transmission 510-b may be an example of a groupcast PSSCH transmission. Each of the PSSCH transmissions 510 may be multiplexed with a corresponding PSCCH transmission that includes SCI related to one of the PSSCH transmissions 510. Each instance of SCI may indicate a total sidelink assignment index and a counter sidelink assignment index for a respective PSSCH transmission (e.g., sidelink message).

As illustrated in the example of FIG. 5A, total sidelink assignment indices and counter sidelink assignment indices may be counted separately for unicast and groupcast PSSCH transmissions. For example, both the PSSCH transmission 510-a and the PSSCH transmission 510-b may be associated with a total sidelink assignment index of 1 and a counter sidelink assignment index of 1 (e.g., because the PSSCH transmission 510-a is unicast and the PSSCH transmission 510-b is groupcast). The PSSCH transmission 510-c may be associated with a total sidelink assignment index of 2 and a counter sidelink assignment index of 2 (e.g., because the PSSCH transmission 510-c is also groupcast).

After monitoring for the PSSCH transmissions 510, the first wireless device may generate the joint codebook 535-a that includes ACK or NACK bits 530 corresponding to the PSSCH transmissions 510. The joint codebook 535-a may include a subset 540-a (e.g., a first sub-codebook) corresponding to unicast PSSCH transmissions and a subset 540-b (e.g., a second sub-codebook) corresponding to groupcast PSSCH transmissions. The subset 540-a may include an ACK or NACK bit 530-a corresponding to the PSSCH transmission 510-a and an ACK or NACK bit 530-b corresponding to the PSSCH transmission 510-c, while the subset 540-b may include an ACK or NACK bit 530-c corresponding to the PSSCH transmission 510-b.

The first wireless device may transmit the joint codebook 535-a on PSFCH resources 515-a in accordance with a sidelink feedback configuration of the first wireless device. As described herein, this sidelink feedback configuration may include a PSFCH periodicity 525-a and a minimum PSFCH gap time 520-a. The PSFCH periodicity 525-a may refer to a number of slots 505 between PSFCH resources 515, while the minimum PSFCH gap time 520-a may refer to a minimum number of slots between when the first wireless device receives a sidelink message (e.g., a PSSCH transmission) and when the first wireless device can transmit feedback (e.g., HARQ-ACK feedback) for the sidelink message. For example, if the first wireless device successfully receives the PSSCH transmission 510-b in the slot 505-b and the minimum PSFCH gap time 520-a is 2 slots, the first wireless device may be unable to transmit HARQ-ACK feedback (e.g., an ACK bit) for the PSSCH transmission 510-b until the minimum PSFCH gap time 520-a has elapsed (e.g., from the slot 505-d). In other words, the first wireless device may transmit HARQ-ACK feedback for the PSSCH transmission 510-b in the first slot that includes PSFCH resources and is at least 2 slots after the last slot in which the first wireless device receives the PSSCH transmission 510-b. In accordance with this sidelink feedback configuration, the first wireless device may transmit an indication of the joint codebook 535-a to the second wireless device on PSFCH resources 515-a located in a slot 505-f.

In the example of FIG. 5B, a first wireless device (e.g., a destination UE) may generate a codebook 535-b and a codebook 535-c (e.g., separate type-2 HARQ-ACK codebooks) that include ACK or NACK bits 530 corresponding to PSSCH transmissions 510. Specifically, the codebook 535-b may include HARQ-ACK feedback for unicast PSSCH transmissions, and the codebook 535-c may include HARQ-ACK feedback for groupcast PSSCH transmissions. As an example, a second wireless device (e.g., a source UE) may transmit a PSSCH transmission 510-d to the first wireless device during a slot 505-g, and may transmit a PSSCH transmission 510-e to the first wireless device during a slot 505-h. The second wireless device may also transmit a PSSCH transmission 510-f to the first wireless device during a slot 505-j. The PSSCH transmission 510-d and the PSSCH transmission 510-f may be examples of unicast PSSCH transmissions, while the PSSCH transmission 510-e may be an example of a groupcast transmission. Each of the PSSCH transmissions 510 may be multiplexed with a corresponding PSCCH transmission that includes SCI related to one of the PSSCH transmissions 510. This SCI may indicate a counter sidelink assignment index and a total sidelink assignment index for a respective PSSCH transmission (e.g., sidelink message).

As illustrated in the example of FIG. 5B, total sidelink assignment indices and counter sidelink assignment indices may be counted separately for unicast and groupcast. For example, both the PSSCH transmission 510-d and the PSSCH transmission 510-e may be associated with a total sidelink assignment index of 1 and a counter sidelink assignment index of 1 (e.g., because the PSSCH transmission 510-d is unicast and the PSSCH transmission 510-e is groupcast). The PSSCH transmission 510-f may be associated with a total sidelink assignment index of 2 and a counter sidelink assignment index of 2 (e.g., because the PSSCH transmission 510-f is also a groupcast PSSCH transmission).

After monitoring for the PSSCH transmissions 510, the first wireless device may generate the codebook 535-b and the codebook 535-c. The codebook 535-b may include an ACK or NACK bit 530-d corresponding to the PSSCH transmission 510-d and an ACK or NACK bit 530-e corresponding to the PSSCH transmission 510-f, while the codebook 535-c may include an ACK or NACK bit 530-f corresponding to the PSSCH transmission 510-e. As described herein, the first wireless device may receive an indication of whether to generate a joint codebook (as illustrated in FIG. 5A) or separate codebooks (as illustrated in FIG. 5B) via RRC signaling from the second wireless device or another network entity.

The first wireless device may transmit an indication of the codebook 535-b on PSFCH resources 515-b, and may transmit an indication of the codebook 535-c on PSFCH resources 515-c. That is, the first wireless device may transmit indications of the codebooks 535 on separate PSFCH resources 515 within a slot 505-1. The first wireless device may transmit these indications in accordance with a sidelink feedback configuration, which may include a PSFCH periodicity 525-b and a minimum PSFCH gap time 520-b. The PSFCH periodicity 525-b may refer to a number of slots 505 between PSFCH resources 515, while the minimum PSFCH gap time 520-b may refer to a minimum number of slots between when the first wireless device receives a sidelink message (e.g., a PSSCH transmission) and when the first wireless device can transmit feedback (e.g., HARQ-ACK feedback) for the sidelink message. For example, if the first wireless device unsuccessfully monitors for the PSSCH transmission 510-e in the slot 505-h and the minimum PSFCH gap time 520-b is 2 slots, the first wireless device may be unable to transmit HARQ-ACK feedback (e.g., a NACK bit) for the PSSCH transmission 510-e until the minimum PSFCH gap time 520-b has elapsed (e.g., after the slot 505-j). In other words, the first wireless device may transmit HARQ-ACK feedback for the PSSCH transmission 510-e in the first slot that includes PSFCH resources and is at least 2 slots after the last slot in which the first wireless device receives the PSSCH transmission 510-e.

The resource mapping 500 and the resource mapping 501 may support techniques for improved sidelink feedback transmission at a wireless device. For example, the techniques and operations described with reference to FIGS. 5A and 5B may enable a wireless device (e.g., a destination UE) to transmit multiple ACK or NACK bits (e.g., corresponding to multiple PSSCH transmissions from a source UE) on a single PSFCH resource, as opposed to transmitting a single ACK or NACK bit per PSFCH resource. As a result, the wireless device may experience higher throughput and greater signaling efficiency, among other benefits.

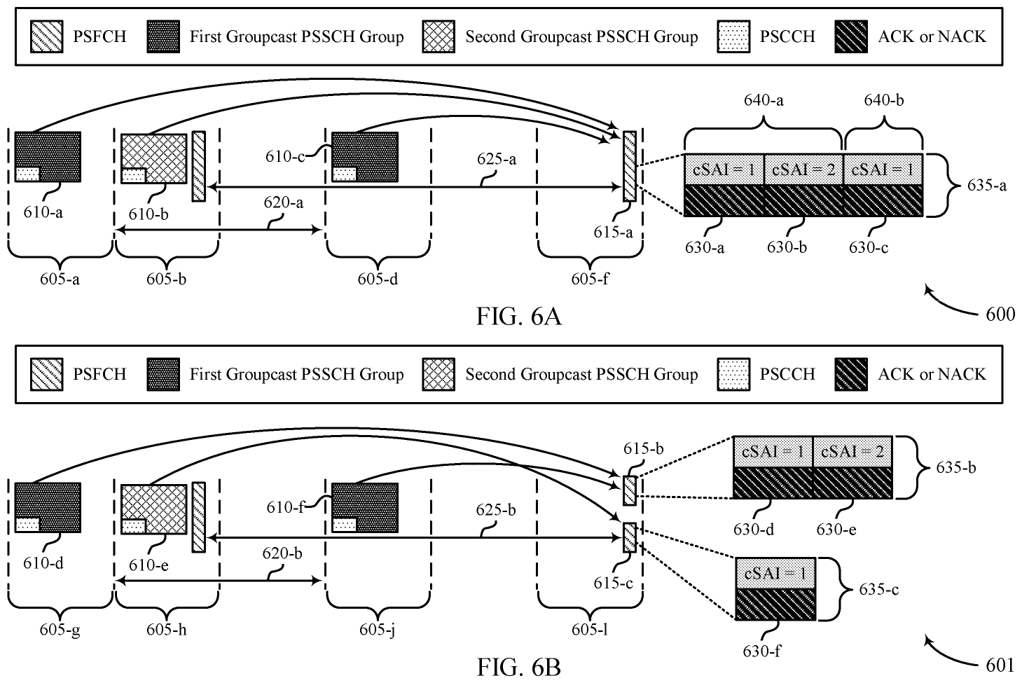

FIGS. 6A and 6B illustrate examples of a resource mapping 600 and a resource mapping 601 that support techniques for enhanced sidelink feedback transmission in accordance with aspects of the present disclosure. The resource mapping 600 and the resource mapping 601 may implement or be implemented by aspects of the wireless communications system 100 or the wireless communications system 200. For example, the resource mapping 600 and the resource mapping 601 may implement or be implemented by a wireless device, which may be an example of a UE 115 described with reference to FIGS. 1 and 2. In accordance with the resource mapping 600, a wireless device (e.g., a destination UE) may generate a joint type-2 HARQ-ACK codebook that includes ACK or NACK bits corresponding to sidelink messages (e.g., PSSCH transmissions) associated with different groupcast PSSCH groups. In accordance with the resource mapping 601, a wireless device may generate separate type-2 HARQ-ACK codebooks that include ACK or NACK bits corresponding to sidelink messages associated with a specific groupcast PSSCH group.

In the example of FIG. 6A, a first wireless device (e.g., a destination UE) may generate a joint codebook 635-a (e.g., a type-2 HARQ-ACK codebook for sidelink communications) that includes ACK or NACK bits 630 corresponding to different groupcast PSSCH groups. As an example, a second wireless device (e.g., a source UE) may transmit a PSSCH transmission 610-a to the first wireless device during a slot 605-a, and may transmit a PSSCH transmission 610-b to the first wireless device during a slot 605-b. The second wireless device may also transmit a PSSCH transmission 610-c to the first wireless device during a slot 605-d. The PSSCH transmission 610-a and the PSSCH transmission 610-c may be associated with a first groupcast PSSCH group, while the PSSCH transmission 610-b may be associated with a second groupcast PSSCH group. Each of the PSSCH transmissions 610 may be multiplexed with a corresponding PSCCH transmission that includes SCI related to one of the PSSCH transmissions 610. Each instance of SCI may indicate a counter sidelink assignment index and a total sidelink assignment index for a respective PSSCH transmission (e.g., sidelink message).

As illustrated in the example of FIG. 6A, total sidelink assignment indices and counter sidelink assignment indices may be counted separately for different groupcast PSSCH groups. For example, both the PSSCH transmission 610-a and the PSSCH transmission 610-b may be associated with a total sidelink assignment index of 1 and a counter sidelink assignment index of 1 (e.g., because these PSSCH transmissions 610 are associated with different groupcast PSSCH groups). The PSSCH transmission 610-c may be associated with a total sidelink assignment index of 2 and a counter sidelink assignment index of 2 (e.g., because the PSSCH transmission 610-c and the PSSCH transmission 610-a are associated with the same groupcast PSSCH group).

After monitoring for the PSSCH transmissions 610, the first wireless device may generate the joint codebook 635-a that includes ACK or NACK bits 630 corresponding to the PSSCH transmissions 610. The joint codebook 635-a may include a subset 640-a (e.g., a first sub-codebook) corresponding to the first groupcast PSSCH group and a subset 640-b (e.g., a second sub-codebook) corresponding to the second groupcast PSSCH group. The subset 640-a may include an ACK or NACK bit 630-a corresponding to the PSSCH transmission 610-a and an ACK or NACK bit 630-b corresponding to the PSSCH transmission 610-c, while the subset 640-b may include an ACK or NACK bit 630-c corresponding to the PSSCH transmission 610-b.

The first wireless device may transmit the joint codebook 635-a on PSFCH resources 615-a in accordance with a sidelink feedback configuration of the first wireless device. As described herein, this sidelink feedback configuration may include a PSFCH periodicity 625-a and a minimum PSFCH gap time 620-a. The PSFCH periodicity 625-a may refer to a number of slots 605 between PSFCH resources 615, while the minimum PSFCH gap time 620-a may refer to a minimum number of slots between when the first wireless device receives a sidelink message (e.g., a PSSCH transmission) and when the first wireless device can transmit feedback (e.g., HARQ-ACK feedback) for the sidelink message. For example, if the first wireless device successfully receives the PSSCH transmission 610-b in the slot 605-b and the minimum PSFCH gap time 620-a is 2 slots, the first wireless device may be unable to transmit HARQ-ACK feedback (e.g., an ACK bit) for the PSSCH transmission 610-b until the minimum PSFCH gap time 620-a has elapsed (e.g., from the slot 605-d). In other words, the first wireless device may transmit HARQ-ACK feedback for the PSSCH transmission 610-b in the first slot that includes PSFCH resources and is at least 2 slots after the last slot in which the first wireless device receives the PSSCH transmission 610-b. In accordance with this sidelink feedback configuration, the first wireless device may transmit an indication of the joint codebook 635-a to the second wireless device on PSFCH resources 615-a located in a slot 605-f.

In the example of FIG. 6B, a first wireless device (e.g., a destination UE) may generate a codebook 635-b and a codebook 635-c (e.g., separate type-2 HARQ-ACK codebooks) that include ACK or NACK bits 630 corresponding to PSSCH transmissions 610. Specifically, the codebook 635-b may include HARQ-ACK feedback for PSSCH transmissions 610 in a first groupcast PSSCH group, and the codebook 635-c may include HARQ-ACK feedback for PSSCH transmissions 610 in a second groupcast PSSCH group. As an example, a second wireless device (e.g., a source UE) may transmit a PSSCH transmission 610-d to the first wireless device during a slot 605-g, and may transmit a PSSCH transmission 610-e to the first wireless device during a slot 605-h. The second wireless device may also transmit a PSSCH transmission 610-f to the first wireless device during a slot 605-j. The PSSCH transmission 610-d and the PSSCH transmission 610-f may be examples of unicast PSSCH transmissions, while the PSSCH transmission 610-e may be an example of a groupcast transmission. Each of the PSSCH transmissions 610 may be multiplexed with a corresponding PSCCH transmission that includes SCI related to one of the PSSCH transmissions 610. Each instance of SCI may indicate a counter sidelink assignment index and a total sidelink assignment index for a respective PSSCH transmission (e.g., sidelink message).

As illustrated in the example of FIG. 6B, total sidelink assignment indices and counter sidelink assignment indices may be counted separately for different groupcast PSSCH groups. For example, both the PSSCH transmission 610-d and the PSSCH transmission 610-e may be associated with a total sidelink assignment index of 1 and a counter sidelink assignment index of 1 (e.g., because these PSSCH transmissions belong to different groupcast PSSCH groups). The PSSCH transmission 610-f may be associated with a total sidelink assignment index of 2 and a counter sidelink assignment index of 2 (e.g., because the PSSCH transmission 610-f and the PSSCH transmission 610-d belong to the same groupcast PSSCH group).

After monitoring for the PSSCH transmissions 610, the first wireless device may generate the codebook 635-b and the codebook 635-c. The codebook 635-b may include an ACK or NACK bit 630-d corresponding to the PSSCH transmission 610-d and an ACK or NACK bit 630-e corresponding to the PSSCH transmission 610-f, while the codebook 635-c may include an ACK or NACK bit 630-f corresponding to the PSSCH transmission 610-e. As described herein, the first wireless device may receive an indication of whether to generate a joint codebook (as illustrated in FIG. 6A) or separate codebooks (as illustrated in FIG. 6B) via RRC signaling from the second wireless device or another network entity.

The first wireless device may transmit an indication of the codebook 635-b on PSFCH resources 615-b, and may transmit an indication of the codebook 635-c on PSFCH resources 615-c. That is, the first wireless device may transmit indications of the codebooks 635 on separate PSFCH resources 615 within a slot 605-1. The first wireless device may transmit these indications in accordance with a sidelink feedback configuration, which may include a PSFCH periodicity 625-b and a minimum PSFCH gap time 620-b. The PSFCH periodicity 625-b may refer to a number of slots 605 between PSFCH resources 615, while the minimum PSFCH gap time 620-b may refer to a minimum number of slots between when the first wireless device receives a sidelink message (e.g., a PSSCH transmission) and when the first wireless device can transmit feedback (e.g., HARQ-ACK feedback) for the sidelink message. For example, if the first wireless device unsuccessfully monitors for the PSSCH transmission 610-e in the slot 605-h and the minimum PSFCH gap time 620-b is 2 slots, the first wireless device may be unable to transmit HARQ-ACK feedback (e.g., a NACK bit) for the PSSCH transmission 610-e until the minimum PSFCH gap time 620-b has elapsed (e.g., after the slot 605-j). In other words, the first wireless device may transmit HARQ-ACK feedback for the PSSCH transmission 610-e in the first slot that includes PSFCH resources and is at least 2 slots after the last slot in which the first wireless device receives the PSSCH transmission 610-e.

The resource mapping 600 and the resource mapping 601 may support techniques for improved sidelink feedback transmission at a wireless device. For example, the techniques and operations described with reference to FIGS. 6A and 6B may enable a wireless device (e.g., a destination UE) to transmit multiple ACK or NACK bits (e.g., corresponding to multiple PSSCH transmissions from a source UE) on a single PSFCH resource, as opposed to transmitting a single ACK or NACK bit per PSFCH resource. As a result, the wireless device may experience higher throughput and greater signaling efficiency, among other benefits.

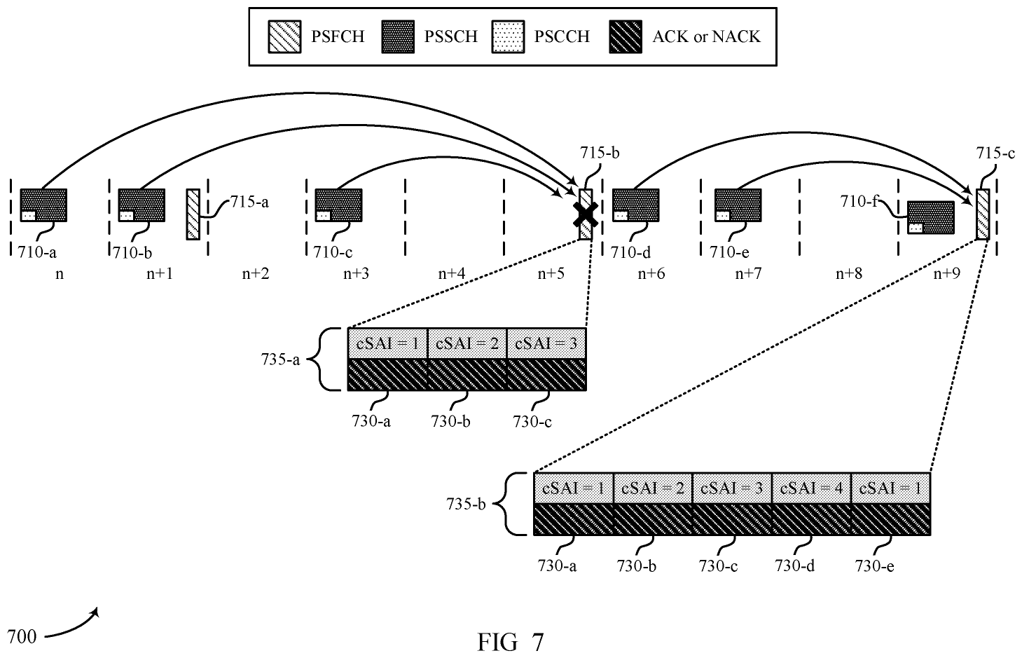

FIG. 7 illustrates an example of a resource mapping 700 that supports techniques for enhanced sidelink feedback transmission in accordance with aspects of the present disclosure. The resource mapping 700 may implement or be implemented by aspects of the wireless communications system 100 or the wireless communications system 200. For example, the resource mapping 700 may implement or be implemented by a wireless device, which may be an example of a UE 115 described with reference to FIGS. 1 and 2. In accordance with the resource mapping 700, a wireless device (e.g., a destination UE) may retransmit an indication of a codebook 735-a on PSFCH resources 715-c after unsuccessfully transmitting an indication of the codebook 735-a on PSFCH resources 715-b.

The resource mapping 700 may support enhanced sidelink type-2 HARQ-ACK codebooks to enable retransmission of HARQ-ACK feedback that was previously transmitted or unsuccessfully transmitted (e.g., due to an LBT failure). The number of PSSCH groups can be hardcoded or configured via RRC signaling. For a single PSSCH group, an ACK-feedback indicator in SCI (e.g., SCI1 or SCI2A) may be used to support enhanced sidelink type-2 HARQ-ACK codebooks. For example, a counter sidelink assignment index and a total sidelink assignment index may be reset when the ACK-feedback indicator is toggled. As such, the counter sidelink assignment index and the total sidelink assignment index may or may not be reset by PSFCH occasions.

In the example of FIG. 7, a first wireless device (e.g., a destination UE) may monitor for PSSCH transmissions 710 from a second wireless device (e.g., a source UE) in multiple slots. For example, the first wireless device may monitor for a PSSCH transmission 710-a, a PSSCH transmission 710-b, a PSSCH transmission 710-c, a PSSCH transmission 710-d, a PSSCH transmission 710-e, and a PSSCH transmission 710-f in a first slot (e.g., slot n), a second slot (e.g., slot n+1), a fourth slot (e.g., slot n+3), a seventh slot (e.g., slot n+6), an eighth slot (e.g., slot n+7), and a tenth slot (e.g., slot n+9), respectively.

Each of the PSSCH transmissions 710 may be multiplexed with a respective PSCCH transmission that includes SCI related to one of the PSSCH transmissions 710. This SCI may indicate a total sidelink assignment index, a counter sidelink assignment index, an ACK feedback indicator, or a combination thereof. In the example of FIG. 7, the PSSCH transmission 710-a may be associated with a total sidelink assignment index of 1, a counter sidelink assignment index of 1, and an ACK feedback indicator of 0. Similarly, the PSSCH transmission 710-b may be associated with a total sidelink assignment index of 2, a counter sidelink assignment index of 2, and an ACK feedback indicator of 0. The PSSCH transmission 710-c may be associated with a total sidelink assignment index of 3, a counter sidelink assignment index of 3, and an ACK feedback indicator of 0. The PSSCH transmission 710-d may be associated with a total sidelink assignment index of 4, a counter sidelink assignment index of 4, and an ACK feedback indicator of 0. The PSSCH transmission 710-e may be associated with a total sidelink assignment index of 1, a counter sidelink assignment index of 1, and an ACK feedback indicator of 0. The PSSCH transmission 710-f may be associated with a total sidelink assignment index of 1, a counter sidelink assignment index of 1, and an ACK feedback indicator of 1.

In some examples, the first wireless device may reset the counter sidelink assignment index and total sidelink assignment of a PSSCH transmission based on a value of an ACK feedback indicator associated with the PSSCH transmission, as opposed to resetting the counter sidelink assignment index and total sidelink assignment of PSSCH transmissions after each PSFCH occasion. For example, the first wireless device may reset the counter sidelink assignment and total sidelink assignment index of the PSSCH transmission 710-f based on a value (e.g., 1) of an ACK feedback indicator associated with the PSSCH transmission 710-f, which can be toggled between different values.

The first wireless device may generate a codebook 735-a (e.g., a first type-2 HARQ-ACK codebook) that includes ACK or NACK bits 730 corresponding to the PSSCH transmissions 710. For example, the codebook 735-a may include an ACK or NACK bit 730-a corresponding to the PSSCH transmission 710-a, an ACK or NACK bit 730-b corresponding to the PSSCH transmission 710-b, and an ACK or NACK bit 730-c corresponding to the PSSCH transmission 710-c. After generating the codebook 735-a, the first wireless device may attempt to transmit an indication of the codebook 735-a on PSFCH resources 715-b in accordance with a sidelink feedback configuration of the first wireless device. Specifically, the first wireless device may identify suitable PSFCH resources 715 to use for transmission of the codebook 735-a based on a PSFCH periodicity and a minimum PSFCH gap time configured for the first wireless device. If, for example, the first wireless device is configured with a minimum PSFCH gap time of 2 slots, the first wireless device may be unable to transmit an indication of the codebook 735-a on PSFCH resources 715-a because the PSFCH resources 715-a are within 2 slots of when the first wireless device received the PSSCH transmissions 710 associated with the codebook 735-a. Thus, the first wireless device may determine to transmit an indication of the codebook 735-a on the PSFCH resources 715-b.

In some examples, however, transmission of the codebook 735-a may be unsuccessful. Specifically, the first wireless device may be unable to transmit an indication of the codebook 735-a on the PSFCH resources 715-b if, for example, the first wireless device experiences an LBT failure (e.g., if the first wireless device is communicating with the second wireless device in an unlicensed radio frequency spectrum band, such as an NR unlicensed (NR-U) frequency band). In other examples, transmission of the codebook 735-a may be unsuccessful due to poor channel conditions or interference at the second wireless device.

In accordance with the techniques described herein, the first wireless device may be configured to retransmit the ACK or NACK bits 730 from the codebook 735-a if an initial transmission of the codebook 735-a is unsuccessful. For example, the first wireless device may append the ACK or NACK bits 730 from the codebook 735-a to a codebook 735-b (e.g., a second type-2 HARQ-ACK codebook), and may transmit an indication of the codebook 735-b on PSFCH resources 715-c. As such, the codebook 735-b may include the ACK or NACK bit 730-a corresponding to the PSSCH transmission 710-a, the ACK or NACK bit 730-b corresponding to the PSSCH transmission 710-b, the ACK or NACK bit 730-c corresponding to the PSSCH transmission 710-c, an ACK or NACK bit 730-d corresponding to the PSSCH transmission 710-d, and an ACK or NACK bit 730-e corresponding to the PSSCH transmission 710-e.

The resource mapping 700 may support techniques for improved sidelink feedback transmission at a wireless device. For example, the techniques and operations described with reference to FIG. 7 may enable a wireless device (e.g., a destination UE) to transmit multiple ACK or NACK bits (e.g., corresponding to multiple PSSCH transmissions from a source UE) on a single PSFCH resource, as opposed to transmitting a single ACK or NACK bit per PSFCH resource. As a result, the wireless device may experience higher throughput and greater signaling efficiency, among other benefits.

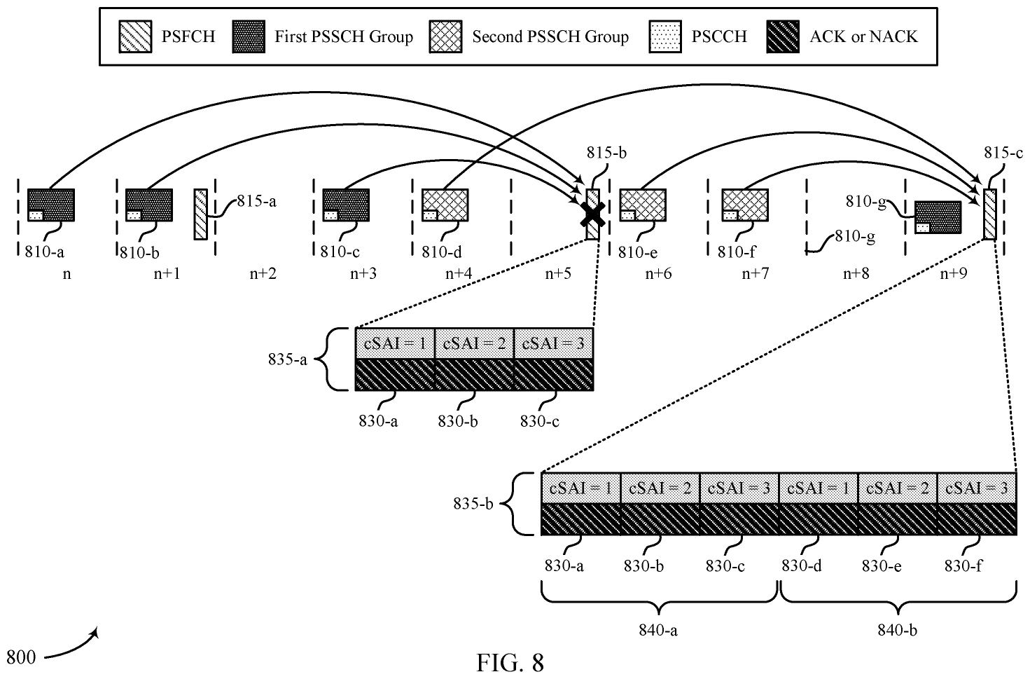

FIG. 8 illustrates an example of a resource mapping 800 that supports techniques for enhanced sidelink feedback transmission in accordance with aspects of the present disclosure. The resource mapping 800 may implement or be implemented by aspects of the wireless communications system 100 or the wireless communications system 200. For example, the resource mapping 800 may implement or be implemented by a wireless device, which may be an example of a UE 115 described with reference to FIGS. 1 and 2. In accordance with the resource mapping 800, a wireless device (e.g., a destination UE) may retransmit an indication of a codebook 835-a on PSFCH resources 815-c after unsuccessfully transmitting an indication of the codebook 835-a on PSFCH resources 815-b.

The resource mapping 800 may support type-2 HARQ-ACK codebooks for two different PSSCH groups. To support this functionality, a group index field may be added to SCI (e.g., SCI1 or SCI2A). A 1-bit HARQ-ACK trigger field may also be added to SCI, where “0” indicates that HARQ-ACK feedback is configured for a scheduled PSSCH group, and “1” indicates that HARQ-ACK feedback is configured for both the scheduled group and a non-scheduled PSSCH group. When both PSSCH groups are triggered by the HARQ-ACK trigger field, the placement of HARQ-ACK feedback for the two PSSCH groups may be ordered in ascending order with respect to group index. SCI may also be modified to include an ACK-feedback indicator and a total sidelink assignment index field for non-scheduled PSSCH groups.

For some devices (e.g., mode 1 UEs), an indication of whether an SCI format includes an ACK feedback indicator and a total sidelink assignment index field for a non-scheduled group may be configured via RRC signaling. For other devices (e.g., mode 2 UEs), an indication of whether an SCI format includes an ACK feedback indicator field and a total sidelink assignment index field for a non-scheduled group may be preconfigured. In such examples, a counter sidelink assignment index and a total sidelink assignment index for the scheduled PSSCH group may be accumulated within the corresponding PSSCH group until the ACK feedback indicator value for the PSSCH group is toggled.

An exemplary SCI format for enhanced type-2 HARQ-ACK codebook transmission on PSFCH resources may include a group index field, a trigger field, an ACK indicator field for the scheduled PSSCH group, an ACK indicator field for the non-scheduled PSSCH group, a counter sidelink assignment index field, a total sidelink assignment index field for the scheduled PSSCH group, and a total sidelink assignment index field for the non-scheduled PSSCH group. The group index field may include 1 bit, where a “0” indicates that the PSSCH group 0 (e.g., the first PSSCH group) is the scheduled PSSCH group, and a “1” indicates that PSSCH group 1 (e.g., the second PSSCH group) is the scheduled PSSCH group. The trigger field may also include 1 bit, where a “0” indicates to only report HARQ-ACK feedback for the scheduled group, and a “1” indicates to also report HARQ-ACK feedback for the non-scheduled group. The ACK indicator field may include 1 bit for the scheduled group and 1 bit for the non-scheduled group. The field for the non-scheduled group may be configurable (e.g., via RRC signaling) or preconfigured. The total sidelink assignment index field may include 2 bits for the scheduled group and 2 bits for the non-scheduled group. The field for the non-scheduled group may be configurable (e.g., via RRC signaling) or preconfigured.

In the example of FIG. 8, a first wireless device (e.g., a destination UE) may monitor for PSSCH transmissions 810 from a second wireless device (e.g., a source UE) in multiple slots. For example, the first wireless device may monitor for a PSSCH transmission 810-a, a PSSCH transmission 810-b, a PSSCH transmission 810-c, a PSSCH transmission 810-d, a PSSCH transmission 810-e, a PSSCH transmission 810-f, and a PSSCH transmission 810-g in a first slot (e.g., slot n), a second slot (e.g., slot n+1), a fourth slot (e.g., slot n+3), a fifth slot (e.g., slot n+4), a seventh slot (e.g., slot n+6), an eighth slot (e.g., slot n+7), and a tenth slot (e.g., slot n+9), respectively.

Each of the PSSCH transmissions 810 may be multiplexed with a respective PSCCH transmission that includes SCI related to one of the PSSCH transmissions 810. This SCI may indicate a total sidelink assignment index for a scheduled PSSCH group, a total sidelink assignment index for a non-scheduled PSSCH group, a counter sidelink assignment index, an ACK feedback indicator (e.g., “NFI”) for the scheduled PSSCH group, an ACK feedback indicator for the non-scheduled PSSCH group, a HARQ-ACK feedback trigger (e.g., “R”), a PSSCH group index, or a combination thereof. In the example of FIG. 8, the PSSCH transmission 810-a may be associated with a group index of 0, a total sidelink assignment index of 1, a counter sidelink assignment index of 1, an ACK feedback indicator of 0, and a HARQ-ACK feedback trigger value of 0. Similarly, the PSSCH transmission 810-b may be associated with a group index of 0, a total sidelink assignment index of 2, a counter sidelink assignment index of 2, an ACK feedback indicator of 0, and a HARQ-ACK feedback trigger value of 0. The PSSCH transmission 810-c may be associated with a group index of 0, a total sidelink assignment index of 3, a counter sidelink assignment index of 3, an ACK feedback indicator of 0, and a HARQ-ACK feedback trigger value of 0.

The PSSCH transmission 810-d may be associated with a group index of 1, a total sidelink assignment index of 1, a counter sidelink assignment index of 1, an ACK feedback indicator of 0, and a HARQ-ACK feedback trigger value of 0. The PSSCH transmission 810-e may be associated with a group index of 1, a total sidelink assignment index of 2, a counter sidelink assignment index of 2, an ACK feedback indicator of 0, and a HARQ-ACK feedback trigger value of 0. The PSSCH transmission 810-f may be associated with a group index of 1, a first total sidelink assignment index of 3 (e.g., corresponding to a scheduled PSSCH group), a second total sidelink assignment index of 3 (e.g., corresponding to a non-scheduled PSSCH group), a counter sidelink assignment index of 3, a first ACK feedback indicator of 0 (e.g., corresponding to the scheduled PSSCH group), a second ACK feedback indicator of 0 (e.g., corresponding to the non-scheduled PSSCH group), and a HARQ-ACK feedback trigger value of 1. The PSSCH transmission 810-g may be associated with a group index of 0, a total sidelink assignment index of 1, a counter sidelink assignment index of 1, an ACK feedback indicator of 1, and a HARQ-ACK feedback trigger value of 0.

As described herein, the first wireless device may reset the counter sidelink assignment index and total sidelink assignment of a PSSCH transmission based on a value of an ACK feedback indicator associated with the PSSCH transmission in a corresponding PSSCH group, as opposed to resetting the counter sidelink assignment index and total sidelink assignment of PSSCH transmissions after each PSFCH occasion. The first wireless device may determine whether to include HARQ-ACK feedback for a scheduled PSSCH group or for both the scheduled PSSCH group and a non-scheduled PSSCH group based on a corresponding HARQ-ACK feedback trigger value and respective ACK feedback indicator values.

The first wireless device may generate a codebook 835-a (e.g., a first type-2 HARQ-ACK codebook) that includes ACK or NACK bits 830 corresponding to some of the PSSCH transmissions 810. For example, the codebook 835-a may include an ACK or NACK bit 830-a corresponding to the PSSCH transmission 810-a, an ACK or NACK bit 830-b corresponding to the PSSCH transmission 810-b, and an ACK or NACK bit 830-c corresponding to the PSSCH transmission 810-c. After generating the codebook 835-a, the first wireless device may attempt to transmit an indication of the codebook 835-a on PSFCH resources 815-b in accordance with a sidelink feedback configuration of the first wireless device. Specifically, the first wireless device may identify suitable PSFCH resources 815 to use for transmission of the codebook 835-a based on a PSFCH periodicity and a minimum PSFCH gap time configured for the first wireless device. If, for example, the first wireless device is configured with a minimum PSFCH gap time of 2 slots, the first wireless device may be unable to transmit an indication of the codebook 835-a on PSFCH resources 815-a because the PSFCH resources 815-a are within 2 slots of when the first wireless device received the PSSCH transmissions 810 associated with the codebook 835-a. Thus, the first wireless device may determine to transmit an indication of the codebook 835-a on the PSFCH resources 815-b.

In some examples, however, transmission of the codebook 835-a may be unsuccessful. Specifically, the first wireless device may be unable to transmit an indication of the codebook 835-a on the PSFCH resources 815-b if, for example, the first wireless device experiences an LBT failure (e.g., if the first wireless device is communicating with the second wireless device in an unlicensed radio frequency spectrum band, such as an NR unlicensed (NR-U) frequency band). In other examples, transmission of the codebook 835-a may be unsuccessful due to poor channel conditions or interference levels at the second wireless device.

In accordance with the techniques described herein, the first wireless device may be configured to retransmit the ACK or NACK bits 830 from the codebook 835-a if an initial transmission of the codebook 835-a is unsuccessful. For example, the first wireless device may receive (e.g., via an instance of SCI associated with the PSSCH transmission 810-f) a HARQ-ACK trigger value of 1, which may indicate to report HARQ-ACK feedback for both a scheduled PSSCH group (e.g., group 1) and a non-scheduled PSSCH group (e.g., group 0). Based on this indication, the first wireless device may append the ACK or NACK bits 830 from the codebook 835-a to a codebook 835-b (e.g., a second type-2 HARQ-ACK codebook), and may transmit an indication of the codebook 835-b on PSFCH resources 815-c. The codebook 835-b may include a subset 840-a (e.g., a first sub-codebook) corresponding to group index 0 (e.g., a non-scheduled PSSCH group) and a subset 840-b (e.g., a second sub-codebook) corresponding to group index 1 (e.g., a scheduled PSSCH group). The subset 840-a may include the ACK or NACK bit 830-a corresponding to the PSSCH transmission 810-a, the ACK or NACK bit 830-b corresponding to the PSSCH transmission 810-b, and the ACK or NACK bit 830-c corresponding to the PSSCH transmission 810-c, while the subset 840-b may include an ACK or NACK bit 830-d corresponding to the PSSCH transmission 810-d, an ACK or NACK bit 830-e corresponding to the PSSCH transmission 810-e, and an ACK or NACK bit 830-f corresponding to the PSSCH transmission 810-f.

The resource mapping 800 may support techniques for improved sidelink feedback transmission at a wireless device. For example, the techniques and operations described with reference to FIG. 8 may enable a wireless device (e.g., a destination UE) to transmit multiple ACK or NACK bits (e.g., corresponding to multiple PSSCH transmissions from a source UE) on a single PSFCH resource, as opposed to transmitting a single ACK or NACK bit per PSFCH resource. As a result, the wireless device may experience higher throughput and greater signaling efficiency, among other benefits.

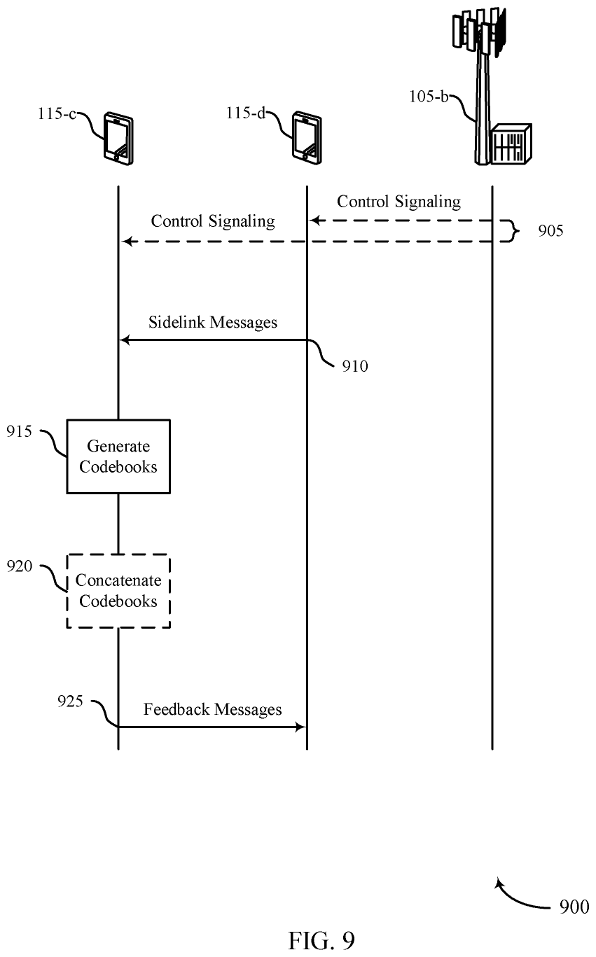

FIG. 9 illustrates an example of a process flow 900 that supports techniques for enhanced sidelink feedback transmission in accordance with aspects of the present disclosure. The process flow 900 may implement or be implemented by aspects of the wireless communications system 100 or the wireless communications system 200. For example, the process flow 900 may include a UE 115-c (e.g., a first wireless device), a UE 115-d (e.g., a second wireless device), and a base station 105-b (e.g., a network entity). In the following description of the process flow 900, operations between the UEs 115 and the base station 105 may be performed in a different order or at a different time than as shown. Additionally or alternatively, some operations may be omitted from the process flow 900, and other operations may be added to the process flow 900.

At 905, the base station 105-b may transmit control signaling (e.g., RRC signaling) to one or both of the UE 115-c or the UE 115-d. The control signaling may indicate a quantity of type-2 HARQ-ACK codebooks to use for sidelink feedback transmission, a quantity of PSSCH groups, a quantity of PSSCH priority levels, a sidelink priority threshold, or an indication of whether to include ACK and NACK bits for sidelink messages associated with different priority levels, different group indices, or both in a joint type-2 HARQ-ACK codebook or in separate type-2 HARQ-ACK codebooks. The control signaling may also indicate other information, such as a mapping between PSSCH resources and PSFCH resources, a PSFCH resource pool configuration, a minimum PSFCH gap time, a PSFCH resource periodicity, or a combination thereof.

At 910, the UE 115-d may transmit multiple sidelink messages to the UE 115-c on PSSCH resources. The sidelink messages may include unicast PSSCH transmissions, groupcast PSSCH transmissions, or a combination thereof. The sidelink messages may also include a first set of PSSCH groupcast transmissions and a second set of PSSCH groupcast transmissions. In some examples, the sidelink messages may be multiplexed with SCI. For example, the UE 115-c may multiplex one or more PSSCH transmissions with one or more corresponding PSCCH transmissions that include SCI. This SCI (e.g., piggyback SCI) may indicate one or more of a first total sidelink assignment index for a scheduled PSSCH group, a second total sidelink assignment index for a non-scheduled PSSCH group, a counter sidelink assignment index, a first ACK feedback indicator for the scheduled PSSCH group, a second ACK feedback indicator for the non-scheduled PSSCH group, a PSSCH group index, or a HARQ-ACK trigger field for a respective PSSCH transmission (e.g., sidelink message).

At 915, the UE 115-c may generate one or more type-2 HARQ-ACK codebooks to report ACK or NACK bits for the sidelink messages from the UE 115-d. The UE 115-c may generate the one or more codebooks in accordance with a sidelink feedback configuration of the UE 115-c. In some examples, the UE 115-c may generate a joint (e.g., mixed) codebook that includes ACK or NACK bits for all of the sidelink messages, even if the sidelink messages are associated with different priority levels or group indices. Alternatively, the UE 115-c may generate separate codebooks that include ACK or NACK bits for sidelink messages associated with a specific priority level or group index. If, for example, the sidelink messages include both unicast and groupcast PSSCH transmissions, the UE 115-c may include ACK or NACK bits for unicast and groupcast PSSCH transmissions in the same codebook or in different codebooks.

In some examples, the UE 115-c may concatenate the one or more codebooks at 920. For example, if the UE 115-c is configured to include ACK or NACK bits for all sidelink messages in a single type-2 HARQ-ACK codebook, the UE 115-c may generate sub-codebooks for sidelink messages with different priority levels or group indices, and may concatenate the sub-codebooks in ascending or descending order with respect to priority level or group index. The UE 115-c may concatenate the sub-codebooks in accordance with a sidelink feedback configuration of the UE 115-c, which may be preconfigured or specified via RRC signaling.

At 925, the UE 115-c may transmit one or more feedback messages to the UE 115-d on one or more PSFCH resources. The one or more feedback messages may indicate ACK or NACK bits corresponding to the sidelink messages from the UE 115-d. Specifically, each feedback message may include an indication of a type-2 HARQ codebook. If, for example, the UE 115-c is configured to generate a joint type-2 HARQ-ACK codebook that includes ACK or NACK feedback for sidelink messages with different priority levels or group indices, the UE 115-c may transmit a single feedback message indicating the joint codebook. Alternatively, if the UE 115-c is configured to generate separate type-2 HARQ-ACK codebooks for different priority levels or groups (e.g., unicast PSSCH groups, groupcast PSSCH groups, or both), the UE 115-c may transmit an indication of each type-2 HARQ-ACK codebook on a separate PSFCH resource in accordance with a sidelink feedback configuration of the UE 115-c.

The process flow 900 may support techniques for improved sidelink feedback transmission at the UE 115-c. For example, the techniques and operations described with reference to FIG. 9 may enable the UE 115-c (e.g., a destination UE) to transmit multiple ACK or NACK bits (e.g., corresponding to multiple PSSCH transmissions from the UE 115-d) on a single PSFCH resource, as opposed to transmitting a single ACK or NACK bit per PSFCH resource. As a result, the UE 115-c may experience higher throughput and greater signaling efficiency, among other benefits.

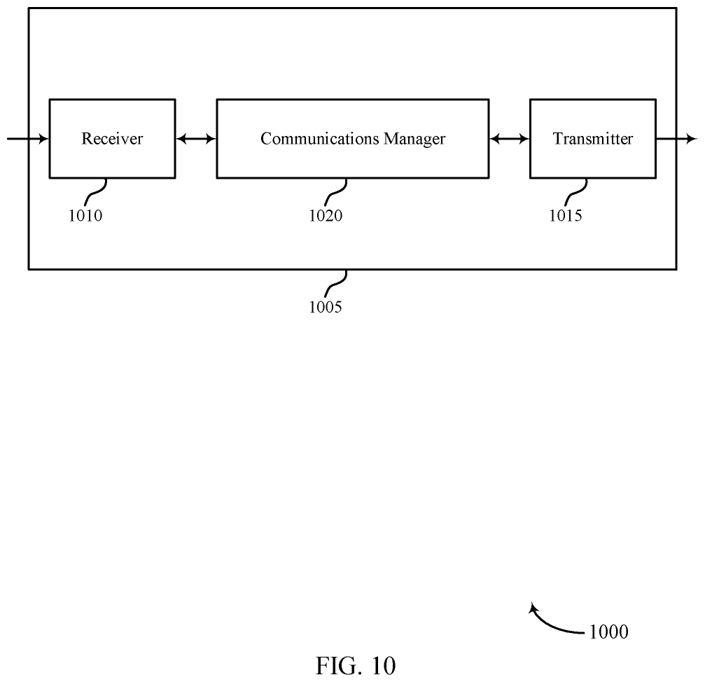

FIG. 10 shows a block diagram 1000 of a device 1005 that supports techniques for enhanced sidelink feedback transmission in accordance with aspects of the present disclosure. The device 1005 may be an example of aspects of a wireless device (e.g., a UE 115) as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for enhanced sidelink feedback transmission). Information may be passed on to other components of the device 1005. The receiver 1010 may utilize a single antenna or multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for enhanced sidelink feedback transmission). In some examples, the transmitter 1015 may be co-located with a receiver 1010 in a transceiver module. The transmitter 1015 may utilize a single antenna or multiple antennas.

The communications manager 1020, the receiver 1010, the transmitter 1015, or various combinations thereof or various components thereof may be examples of means for performing various aspects of techniques for enhanced sidelink feedback transmission as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), an application-specific integrated circuit (ASIC), a field programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a first wireless device (e.g., a UE 115) in accordance with examples as disclosed herein. For example, the communications manager 1020 may be configured as or otherwise support a means for monitoring multiple sidelink resources for multiple sidelink messages from a second wireless device. The communications manager 1020 may be configured as or otherwise support a means for generating one or more codebooks including multiple ACK or NACK bits corresponding to the multiple sidelink messages. The communications manager 1020 may be configured as or otherwise support a means for transmitting a set of feedback messages to the second wireless device over a set of feedback resources in accordance with a sidelink feedback configuration of the first wireless device, the set of feedback messages including an indication of the one or more codebooks.

Additionally or alternatively, the communications manager 1020 may support wireless communications at a first wireless device (e.g., a UE 115) in accordance with examples as disclosed herein. For example, the communications manager 1020 may be configured as or otherwise support a means for transmitting, to a second wireless device, control signaling indicating a sidelink feedback configuration for the second wireless device. The communications manager 1020 may be configured as or otherwise support a means for transmitting multiple sidelink messages to the second wireless device over multiple sidelink resources. The communications manager 1020 may be configured as or otherwise support a means for monitoring a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced power consumption by performing fewer sidelink feedback transmissions. For example, the techniques described herein may enable the device 1005 to transmit multiple ACK or NACK bits (e.g., for multiple PSSCH transmissions) on a single PSFCH resource, as opposed to transmitting one ACK or NACK bit per PSFCH resource. As a result, the device 1005 may perform fewer transmissions, which may result in greater power savings at the device 1005.

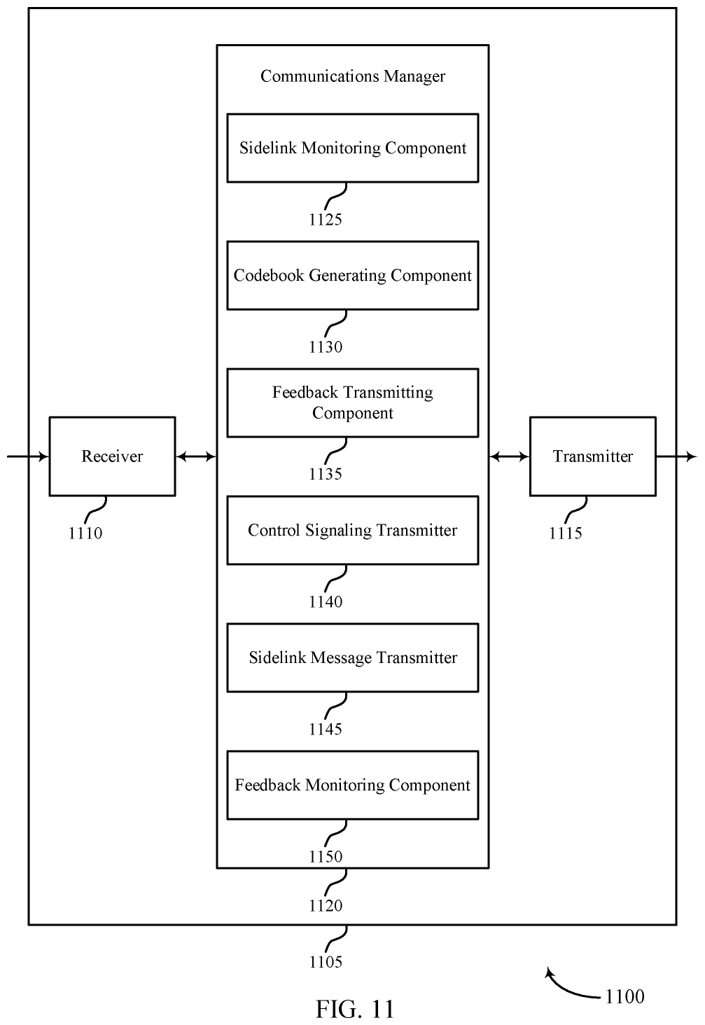

FIG. 11 shows a block diagram 1100 of a device 1105 that supports techniques for enhanced sidelink feedback transmission in accordance with aspects of the present disclosure. The device 1105 may be an example of aspects of a device 1005 or a wireless device (e.g., a UE 115) as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for enhanced sidelink feedback transmission). Information may be passed on to other components of the device 1105. The receiver 1110 may utilize a single antenna or multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for enhanced sidelink feedback transmission). In some examples, the transmitter 1115 may be co-located with a receiver 1110 in a transceiver module. The transmitter 1115 may utilize a single antenna or multiple antennas.

The device 1105, or various components thereof, may be an example of means for performing various aspects of techniques for enhanced sidelink feedback transmission as described herein. For example, the communications manager 1120 may include a sidelink monitoring component 1125, a codebook generating component 1130, a feedback transmitting component 1135, a control signaling transmitter 1140, a sidelink message transmitter 1145, a feedback monitoring component 1150, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a first wireless device (e.g., a UE 115) in accordance with examples as disclosed herein. The sidelink monitoring component 1125 may be configured as or otherwise support a means for monitoring multiple sidelink resources for multiple sidelink messages from a second wireless device. The codebook generating component 1130 may be configured as or otherwise support a means for generating one or more codebooks including multiple ACK or NACK bits corresponding to the multiple sidelink messages. The feedback transmitting component 1135 may be configured as or otherwise support a means for transmitting a set of feedback messages to the second wireless device over a set of feedback resources in accordance with a sidelink feedback configuration of the first wireless device, the set of feedback messages including an indication of the one or more codebooks.

Additionally or alternatively, the communications manager 1120 may support wireless communications at a first wireless device (e.g., a UE 115) in accordance with examples as disclosed herein. The control signaling transmitter 1140 may be configured as or otherwise support a means for transmitting, to a second wireless device, control signaling indicating a sidelink feedback configuration for the second wireless device. The sidelink message transmitter 1145 may be configured as or otherwise support a means for transmitting multiple sidelink messages to the second wireless device over multiple sidelink resources. The feedback monitoring component 1150 may be configured as or otherwise support a means for monitoring a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages.

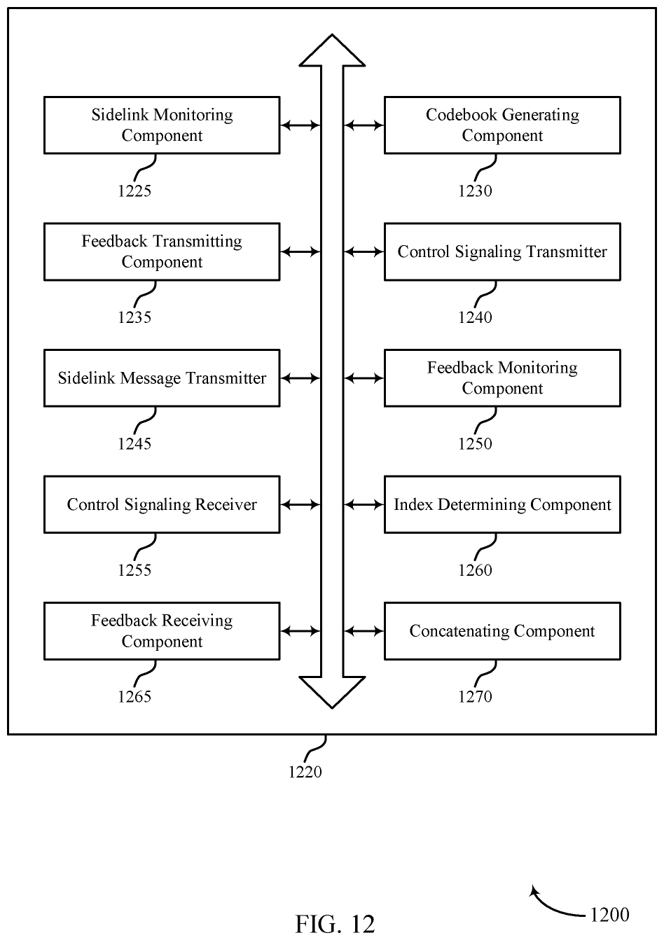

FIG. 12 shows a block diagram 1200 of a communications manager 1220 that supports techniques for enhanced sidelink feedback transmission in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of techniques for enhanced sidelink feedback transmission as described herein. For example, the communications manager 1220 may include a sidelink monitoring component 1225, a codebook generating component 1230, a feedback transmitting component 1235, a control signaling transmitter 1240, a sidelink message transmitter 1245, a feedback monitoring component 1250, a control signaling receiver 1255, an index determining component 1260, a feedback receiving component 1265, a concatenating component 1270, or any combination thereof. Each of these components may communicate, directly or indirectly, with one another (e.g., via one or more buses).

The communications manager 1220 may support wireless communications at a first wireless device (e.g., a UE 115) in accordance with examples as disclosed herein. The sidelink monitoring component 1225 may be configured as or otherwise support a means for monitoring multiple sidelink resources for multiple sidelink messages from a second wireless device. The codebook generating component 1230 may be configured as or otherwise support a means for generating one or more codebooks including multiple ACK or NACK bits corresponding to the multiple sidelink messages. The feedback transmitting component 1235 may be configured as or otherwise support a means for transmitting a set of feedback messages to the second wireless device over a set of feedback resources in accordance with a sidelink feedback configuration of the first wireless device, the set of feedback messages including an indication of the one or more codebooks.

In some examples, to support generating the one or more codebooks, the codebook generating component 1230 may be configured as or otherwise support a means for generating a joint codebook that includes the multiple ACK or NACK bits corresponding to the multiple sidelink messages that are associated with different priority levels, different group indices, or both.

In some examples, to support generating the joint codebook, the codebook generating component 1230 may be configured as or otherwise support a means for generating a first subset of the joint codebook that includes ACK or NACK bits corresponding to a first subset of sidelink messages from the multiple sidelink messages, the first subset of sidelink messages associated with a first priority level. In some examples, to support generating the joint codebook, the codebook generating component 1230 may be configured as or otherwise support a means for generating a second subset of the joint codebook that includes ACK or NACK bits corresponding to a second subset of sidelink messages from the multiple sidelink messages, the second subset of sidelink messages associated with a second priority level that is different from the first priority level.

In some examples, to support generating the joint codebook, the codebook generating component 1230 may be configured as or otherwise support a means for generating a first subset of the joint codebook that includes ACK or NACK bits corresponding to a first subset of sidelink messages from the multiple sidelink messages, the first subset of sidelink messages associated with a first group index. In some examples, to support generating the joint codebook, the codebook generating component 1230 may be configured as or otherwise support a means for generating a second subset of the joint codebook that includes ACK or NACK bits corresponding to a second subset of sidelink messages from the multiple sidelink messages, the second subset of sidelink messages associated with a second group index.

In some examples, the first group index corresponds to a set of priority levels that are below a sidelink priority threshold and the second group index corresponds to a set of priority levels that are above the sidelink priority threshold.

In some examples, the concatenating component 1270 may be configured as or otherwise support a means for concatenating different subsets of the joint codebook in ascending order or descending order with respect to priority level or group index.

In some examples, to support transmitting the set of feedback messages, the feedback transmitting component 1235 may be configured as or otherwise support a means for transmitting an indication of the joint codebook over a PSFCH resource in accordance with the sidelink feedback configuration.

In some examples, the multiple sidelink messages are associated with a respective multiple priority levels, a respective multiple group indices, or both. In some examples, the sidelink feedback configuration indicates a sidelink priority threshold, a first mapping between the respective multiple priority levels and the one or more codebooks, a second mapping between the respective multiple group indices and the one or more codebooks, or a combination thereof.

In some examples, the multiple sidelink messages are multiplexed with respective instances of SCI. In some examples, each respective instance of SCI includes an indication of a counter sidelink assignment index and a total sidelink assignment index associated with a sidelink message from the multiple sidelink messages. In some examples, the counter sidelink assignment index and the total sidelink assignment index are specific to a priority level, a group index, or both. In some examples, the counter sidelink assignment index and the total sidelink assignment index are applicable to different priority levels, different group indices, or both.

In some examples, to support generating the one or more codebooks, the codebook generating component 1230 may be configured as or otherwise support a means for generating a first codebook that includes ACK or NACK bits corresponding to a first subset of sidelink messages from the multiple sidelink messages, the first subset of sidelink messages associated with a first priority level. In some examples, to support generating the one or more codebooks, the codebook generating component 1230 may be configured as or otherwise support a means for generating a second codebook that includes ACK or NACK bits corresponding to a second subset of sidelink messages from the multiple sidelink messages, the second subset of sidelink messages associated with a second priority level that is different from the first priority level.

In some examples, to support generating the one or more codebooks, the codebook generating component 1230 may be configured as or otherwise support a means for generating a first codebook that includes ACK or NACK bits corresponding to a first subset of sidelink messages from the multiple sidelink messages, the first subset of sidelink messages associated with a first group index. In some examples, to support generating the one or more codebooks, the codebook generating component 1230 may be configured as or otherwise support a means for generating a second codebook that includes ACK or NACK bits corresponding to a second subset of sidelink messages from the multiple sidelink messages, the second subset of sidelink messages associated with a second group index that is different from the first group index.

In some examples, to support transmitting the set of feedback messages, the feedback transmitting component 1235 may be configured as or otherwise support a means for transmitting, over a first PSFCH resource, a first feedback message indicating a first codebook of the one or more codebooks, the first codebook including ACK or NACK bits corresponding to a first subset of sidelink messages from the multiple sidelink messages, the first subset of sidelink messages associated with a first priority level, a first group index, or both. In some examples, to support transmitting the set of feedback messages, the feedback transmitting component 1235 may be configured as or otherwise support a means for transmitting, over a second PSFCH resource, a second feedback message indicating a second codebook of the one or more codebooks, the second codebook including ACK or NACK bits corresponding to a second subset of sidelink messages from the multiple sidelink messages, the second subset of sidelink messages associated with a second priority level, a second group index, or both.

In some examples, the control signaling receiver 1255 may be configured as or otherwise support a means for receiving control signaling indicating one or more of a quantity of the one or more codebooks, a quantity of PSSCH groups, a quantity of PSSCH priority levels, a sidelink priority threshold, or an indication of whether to include ACK or NACK bits for sidelink messages associated with different priority levels, different group indices, or both in a joint codebook or in separate codebooks, where generating the one or more codebooks is based on the control signaling.

In some examples, the multiple sidelink messages include unicast PSSCH transmissions. In some examples, the multiple sidelink messages include unicast PSSCH transmissions, groupcast PSSCH transmissions, or both. In some examples, the unicast PSSCH transmissions and the groupcast PSSCH transmissions are associated with separate counter sidelink assignment indices and separate total sidelink assignment indices.

In some examples, to support generating the one or more codebooks, the codebook generating component 1230 may be configured as or otherwise support a means for generating a joint codebook that includes ACK or NACK bits corresponding to the unicast PSSCH transmissions and the groupcast PSSCH transmissions.

In some examples, to support generating the joint codebook, the codebook generating component 1230 may be configured as or otherwise support a means for generating a first subset of the joint codebook that includes ACK or NACK bits corresponding to the unicast PSSCH transmissions. In some examples, to support generating the joint codebook, the codebook generating component 1230 may be configured as or otherwise support a means for generating a second subset of the joint codebook that includes ACK or NACK bits corresponding to the groupcast PSSCH transmissions, where the first subset of the joint codebook precedes the second subset of the joint codebook.

In some examples, to support transmitting the set of feedback messages, the feedback transmitting component 1235 may be configured as or otherwise support a means for transmitting an indication of the joint codebook on a PSFCH resource in accordance with the sidelink feedback configuration.

In some examples, to support transmitting the set of feedback messages, the feedback transmitting component 1235 may be configured as or otherwise support a means for transmitting, over a first PSFCH resource, a first feedback message indicating a first codebook of the one or more codebooks, the first codebook including ACK or NACK bits corresponding to the unicast PSSCH transmissions. In some examples, to support transmitting the set of feedback messages, the feedback transmitting component 1235 may be configured as or otherwise support a means for transmitting, over a second PSFCH resource, a second feedback message indicating a second codebook of the one or more codebooks, the second codebook including ACK or NACK bits corresponding to the groupcast PSSCH transmissions.

In some examples, the control signaling receiver 1255 may be configured as or otherwise support a means for receiving RRC signaling indicating whether to include ACK or NACK bits for the unicast PSSCH transmissions and ACK or NACK bits for the groupcast PSSCH transmissions in a single codebook or in different codebooks, where generating the one or more codebooks is based on the RRC signaling.

In some examples, the control signaling receiver 1255 may be configured as or otherwise support a means for receiving RRC signaling indicating the sidelink feedback configuration, where transmitting the set of feedback messages to the second wireless device is based on the RRC signaling.

In some examples, the multiple sidelink messages includes a first set of groupcast PSSCH transmissions associated with a first group identifier and a second set of groupcast PSSCH transmissions associated with a second group identifier.

In some examples, to support generating the one or more codebooks, the codebook generating component 1230 may be configured as or otherwise support a means for generating a joint codebook that includes acknowledgment or NACK bits corresponding to the first set of groupcast PSSCH transmissions and the second set of groupcast PSSCH transmissions.

In some examples, to support generating the joint codebook, the codebook generating component 1230 may be configured as or otherwise support a means for generating a first subset of the joint codebook that includes acknowledgment or NACK bits corresponding to the first set of groupcast PSSCH transmissions. In some examples, to support generating the joint codebook, the codebook generating component 1230 may be configured as or otherwise support a means for generating a second subset of the joint codebook that includes acknowledgment or NACK bits corresponding to the second set of groupcast PSSCH transmissions.

In some examples, the concatenating component 1270 may be configured as or otherwise support a means for concatenating different subsets of the joint codebook in ascending order with respect to group identifier.

In some examples, to support generating the one or more codebooks, the codebook generating component 1230 may be configured as or otherwise support a means for generating a first codebook that includes ACK or NACK bits corresponding to the first set of groupcast PSSCH transmissions. In some examples, to support generating the one or more codebooks, the codebook generating component 1230 may be configured as or otherwise support a means for generating a second codebook that includes ACK or NACK bits corresponding to the second set of groupcast PSSCH transmissions.

In some examples, to support transmitting the set of feedback messages, the feedback transmitting component 1235 may be configured as or otherwise support a means for transmitting indications of the first codebook and the second codebook on different PSFCH resources in accordance with the sidelink feedback configuration.

In some examples, the control signaling receiver 1255 may be configured as or otherwise support a means for receiving RRC signaling indicating whether to include acknowledgment or negative acknowledgment bits for the first set of groupcast PSSCH transmissions and acknowledgment or negative acknowledgment bits for the second set of groupcast PSSCH transmissions in a single codebook or in different codebooks, where generating the one or more codebooks is based on the RRC signaling.

In some examples, the feedback transmitting component 1235 may be configured as or otherwise support a means for retransmitting the set of feedback messages based on a result of an LBT procedure, an unsuccessful initial transmission, or both.

In some examples, the control signaling receiver 1255 may be configured as or otherwise support a means for receiving SCI that indicates an ACK feedback indicator associated with the multiple sidelink messages. In some examples, the index determining component 1260 may be configured as or otherwise support a means for determining whether one or both of a counter sidelink assignment index or a total sidelink assignment index for a subsequent sidelink message are reset based on a value of the ACK feedback indicator.

In some examples, to support generating the one or more codebooks, the codebook generating component 1230 may be configured as or otherwise support a means for generating a codebook that includes ACK or NACK bits corresponding to the multiple sidelink messages that are associated with a same value of the ACK feedback indicator.

In some examples, the control signaling receiver 1255 may be configured as or otherwise support a means for receiving SCI indicating a PSSCH group index, a HARQ-ACK trigger field, or both. In some examples, the index determining component 1260 may be configured as or otherwise support a means for determining whether to report HARQ-ACK feedback for a first PSSCH group, a second PSSCH group, or both based on the SCI.

In some examples, to support generating the one or more codebooks, the codebook generating component 1230 may be configured as or otherwise support a means for generating, based on a value of the HARQ-ACK trigger field, the one or more codebooks that include HARQ-ACK feedback for the first PSSCH group and the second PSSCH group, where the one or more codebooks are concatenated in ascending order with respect to PSSCH group index.

In some examples, the control signaling receiver 1255 may be configured as or otherwise support a means for receiving SCI indicating a counter sidelink assignment index, a total sidelink assignment index, an ACK feedback indicator, or a combination thereof. In some examples, the index determining component 1260 may be configured as or otherwise support a means for determining whether one or both of the total sidelink assignment index or the counter sidelink assignment index for a PSSCH group are reset based on a value of the ACK feedback indicator.

In some examples, the control signaling receiver 1255 may be configured as or otherwise support a means for receiving SCI indicating an ACK feedback indicator and a total sidelink assignment index associated with a PSSCH group, where generating the one or more codebooks is based on receiving the SCI.

In some examples, the control signaling receiver 1255 may be configured as or otherwise support a means for receiving RRC signaling indicating a SCI format that includes a group index field, a HARQ-ACK trigger field, a first acknowledgment feedback indicator field associated with a first physical sidelink shared channel group, a second ACK feedback indicator field associated with a second physical sidelink shared channel group, a counter sidelink assignment index field, a first total sidelink assignment index field associated with the first physical sidelink shared channel group, a second total sidelink assignment index field associated with the second physical sidelink shared channel group, or a combination thereof.

Additionally or alternatively, the communications manager 1220 may support wireless communications at a first wireless device (e.g., a UE 115) in accordance with examples as disclosed herein. The control signaling transmitter 1240 may be configured as or otherwise support a means for transmitting, to a second wireless device, control signaling indicating a sidelink feedback configuration for the second wireless device. The sidelink message transmitter 1245 may be configured as or otherwise support a means for transmitting multiple sidelink messages to the second wireless device over multiple sidelink resources. The feedback monitoring component 1250 may be configured as or otherwise support a means for monitoring a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages.

In some examples, the feedback receiving component 1265 may be configured as or otherwise support a means for receiving, from the second wireless device over a PSFCH resource, an indication of a joint codebook that includes the multiple ACK or NACK bits corresponding to the multiple sidelink messages that are associated with different priority levels, different group indices, or both.

In some examples, the multiple sidelink messages are associated with a respective multiple priority levels, a respective multiple group indices, or both. In some examples, the sidelink feedback configuration indicates a sidelink priority threshold, a first mapping between the respective multiple priority levels and the one or more codebooks, a second mapping between the respective multiple group indices and the one or more codebooks, or a combination thereof.

In some examples, the multiple sidelink messages are multiplexed with respective instances of SCI. In some examples, each respective instance of SCI includes an indication of a counter sidelink assignment index and a total sidelink assignment index associated with a sidelink message from the multiple sidelink messages. In some examples, the counter sidelink assignment index and the total sidelink assignment index are specific to a priority level, a group index, or both. In some examples, the counter sidelink assignment index and the total sidelink assignment index are applicable to different priority levels, different group indices, or both.

In some examples, the feedback receiving component 1265 may be configured as or otherwise support a means for receiving, over a first PSFCH resource, a first feedback message indicating a first codebook of the one or more codebooks, the first codebook including ACK or NACK bits corresponding to a first subset of sidelink messages from the multiple sidelink messages, the first subset of sidelink messages associated with a first priority level, a first group index, or both. In some examples, the feedback receiving component 1265 may be configured as or otherwise support a means for receiving, over a second PSFCH resource, a second feedback message indicating a second codebook of the one or more codebooks, the second codebook including ACK or NACK bits corresponding to a second subset of sidelink messages from the multiple sidelink messages, the second subset of sidelink messages associated with a second priority level, a second group index, or both.

In some examples, to support transmitting the control signaling, the control signaling transmitter 1240 may be configured as or otherwise support a means for transmitting RRC signaling that indicates a quantity of the one or more codebooks, a quantity of PSSCH groups, a quantity of PSSCH priority levels, a sidelink priority threshold, or a combination thereof.

In some examples, the multiple sidelink messages include unicast PSSCH transmissions. In some examples, the multiple sidelink messages include unicast PSSCH transmissions, groupcast PSSCH transmissions, or both. In some examples, the unicast PSSCH transmissions and the groupcast PSSCH transmissions are associated with separate counter sidelink assignment indices and separate total sidelink assignment indices. In some examples, the multiple sidelink messages includes a first set of groupcast PSSCH transmissions associated with a first group identifier and a second set of groupcast PSSCH transmissions associated with a second group identifier.

In some examples, the feedback receiving component 1265 may be configured as or otherwise support a means for receiving, over a PSFCH resource, a feedback message indicating a joint codebook that includes ACK or negative acknowledgment bits corresponding to the unicast PSSCH transmissions and ACK or negative acknowledgment bits corresponding to the groupcast PSSCH transmissions.

In some examples, the feedback receiving component 1265 may be configured as or otherwise support a means for receiving, over a first PSFCH resource, a first feedback message indicating a first codebook that includes ACK or NACK bits corresponding to the unicast PSSCH transmissions. In some examples, the feedback receiving component 1265 may be configured as or otherwise support a means for receiving, over a second PSFCH resource, a second feedback message indicating a second codebook that includes ACK or NACK bits corresponding to the groupcast PSSCH transmissions.

In some examples, to support transmitting the control signaling, the control signaling transmitter 1240 may be configured as or otherwise support a means for transmitting RRC signaling that indicates whether to include ACK or NACK bits for the unicast PSSCH transmissions and ACK or NACK bits for the groupcast PSSCH transmissions in a single codebook or in different codebooks.

In some examples, to support transmitting the control signaling, the control signaling transmitter 1240 may be configured as or otherwise support a means for transmitting RRC signaling that indicates whether to include acknowledgment or negative acknowledgment bits for the first set of groupcast PSSCH transmissions and acknowledgment or negative acknowledgment bits for the second set of groupcast PSSCH transmissions in a single codebook or in different codebooks.

In some examples, the feedback receiving component 1265 may be configured as or otherwise support a means for receiving, over a first PSFCH resource, a first feedback message indicating a first codebook that includes ACK or NACK bits corresponding to a first set of groupcast PSSCH transmissions. In some examples, the feedback receiving component 1265 may be configured as or otherwise support a means for receiving, over a second PSFCH resource, a second feedback message indicating a second codebook that includes ACK or NACK bits corresponding to a second set of groupcast PSSCH transmissions.

In some examples, the feedback receiving component 1265 may be configured as or otherwise support a means for receiving a feedback message indicating a codebook that includes ACK or NACK bits corresponding to the multiple sidelink messages that are associated with a same acknowledgment feedback indicator value.

In some examples, the control signaling transmitter 1240 may be configured as or otherwise support a means for transmitting SCI indicating a PSSCH group index, a HARQ-ACK trigger field, a first ACK feedback indicator associated with a first physical sidelink shared channel group, a second ACK feedback indicator associated with a second physical sidelink shared channel group, a counter sidelink assignment index, a first total sidelink assignment index associated with the first physical sidelink shared channel group, a second total sidelink assignment index associated with the second physical sidelink shared channel group, or a combination thereof.

In some examples, to support transmitting the control signaling, the control signaling transmitter 1240 may be configured as or otherwise support a means for transmitting RRC signaling indicating a SCI format that includes a group index field, a HARQ-ACK trigger field, a first acknowledgment feedback indicator field associated with a first physical sidelink shared channel group, a second ACK feedback indicator field associated with a second physical sidelink shared channel group, a counter sidelink assignment index field, a first total sidelink assignment index field associated with the first physical sidelink shared channel group, a second total sidelink assignment index field associated with the second physical sidelink shared channel group, or a combination thereof.

In some examples, to support transmitting the control signaling, the control signaling transmitter 1240 may be configured as or otherwise support a means for transmitting SCI indicating a counter sidelink assignment index, a total sidelink assignment index, an ACK feedback indicator, or a combination thereof, where a value of the ACK feedback indicator indicates whether one or both of the total sidelink assignment index or the counter sidelink assignment index are reset for a PSSCH group.

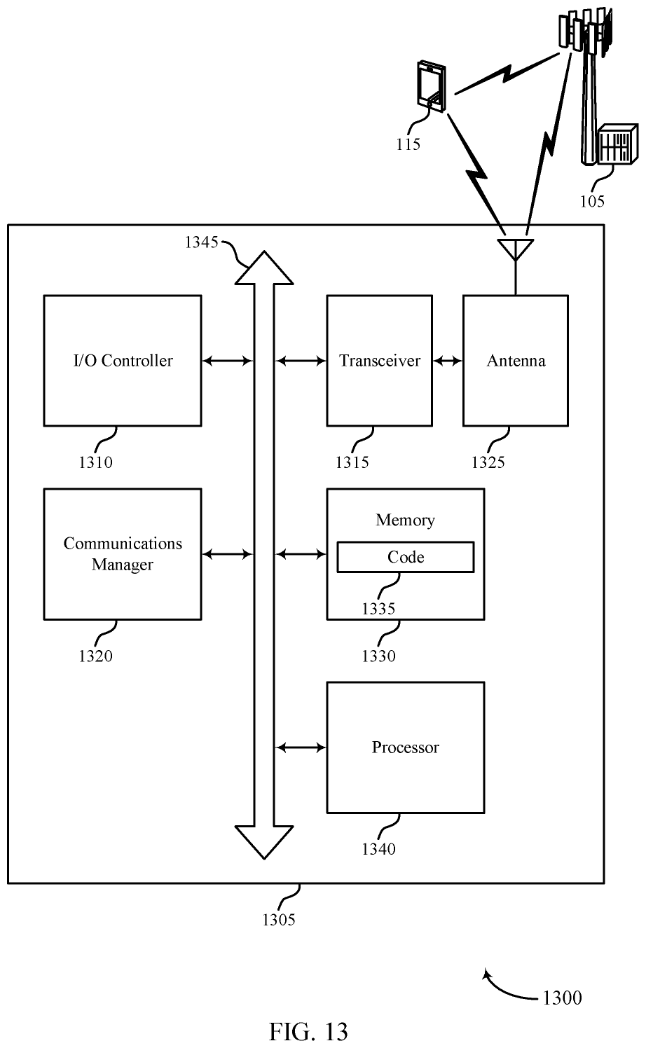

FIG. 13 shows a diagram of a system 1300 including a device 1305 that supports techniques for enhanced sidelink feedback transmission in accordance with aspects of the present disclosure. The device 1305 may be an example of or include the components of a device 1005, a device 1105, or a wireless device (e.g., a UE 115) as described herein. The device 1305 may include components for bi-directional voice and data communications including components for transmitting and receiving communications, such as a communications manager 1320, an I/O controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for enhanced sidelink feedback transmission). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communications at a first wireless device (e.g., a UE 115) in accordance with examples as disclosed herein. For example, the communications manager 1320 may be configured as or otherwise support a means for monitoring multiple sidelink resources for multiple sidelink messages from a second wireless device. The communications manager 1320 may be configured as or otherwise support a means for generating one or more codebooks including multiple ACK or NACK bits corresponding to the multiple sidelink messages. The communications manager 1320 may be configured as or otherwise support a means for transmitting a set of feedback messages to the second wireless device over a set of feedback resources in accordance with a sidelink feedback configuration of the first wireless device, the set of feedback messages including an indication of the one or more codebooks.

Additionally or alternatively, the communications manager 1320 may support wireless communications at a first wireless device (e.g., a UE 115) in accordance with examples as disclosed herein. For example, the communications manager 1320 may be configured as or otherwise support a means for transmitting, to a second wireless device, control signaling indicating a sidelink feedback configuration for the second wireless device. The communications manager 1320 may be configured as or otherwise support a means for transmitting multiple sidelink messages to the second wireless device over multiple sidelink resources. The communications manager 1320 may be configured as or otherwise support a means for monitoring a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages.

By including or configuring the communications manager 1320 in accordance with examples as described herein, the device 1305 may support techniques for higher throughput and greater signaling efficiency by transmitting multiple ACK or NACK bits (e.g., for multiple PSSCH transmissions) on a single PSFCH resource. For example, the device 1305 may generate one or more codebooks (e.g., type-2 HARQ-ACK codebooks) that include multiple ACK or NACK bits. The device 1305 may transmit an indication of the one or more codebooks on one or more PSFCH resources. Transmitting multiple ACK or NACK bits per PSFCH resource may enable the device 1305 to attain higher throughput levels and greater signaling efficiency (e.g., by reducing a number of transmissions from the device 1305), among other benefits.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for enhanced sidelink feedback transmission as described herein, or the processor 1340 and the memory 1330 may be otherwise configured to perform or support such operations.

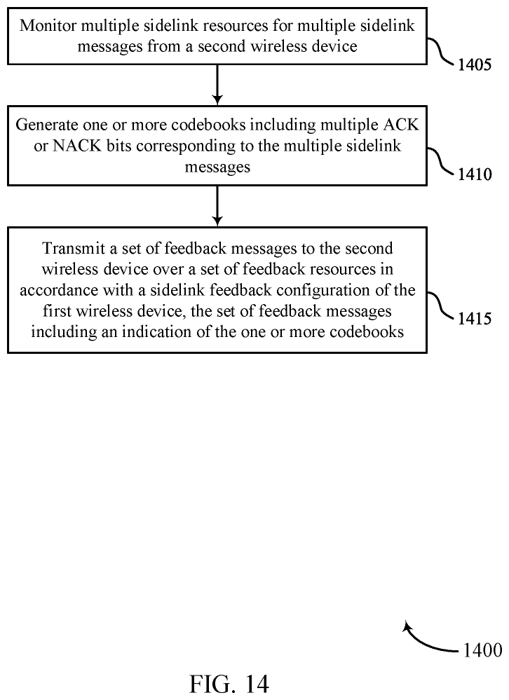

FIG. 14 shows a flowchart illustrating a method 1400 that supports techniques for enhanced sidelink feedback transmission in accordance with aspects of the present disclosure. The operations of the method 1400 may be implemented by a wireless device or its components as described herein. For example, the operations of the method 1400 may be performed by a UE 115 as described with reference to FIGS. 1 through 13. In some examples, a wireless device may execute a set of instructions to control the functional elements of the wireless device to perform the described functions. Additionally or alternatively, the wireless device may perform aspects of the described functions using special-purpose hardware.

At 1405, the method may include monitoring multiple sidelink resources for multiple sidelink messages from a second wireless device. The operations of 1405 may be performed in accordance with examples as disclosed herein. In some examples, aspects of the operations of 1405 may be performed by a sidelink monitoring component 1225 as described with reference to FIG. 12.

At 1410, the method may include generating one or more codebooks including multiple ACK or NACK bits corresponding to the multiple sidelink messages. The operations of 1410 may be performed in accordance with examples as disclosed herein. In some examples, aspects of the operations of 1410 may be performed by a codebook generating component 1230 as described with reference to FIG. 12.

At 1415, the method may include transmitting a set of feedback messages to the second wireless device over a set of feedback resources in accordance with a sidelink feedback configuration of the first wireless device, the set of feedback messages including an indication of the one or more codebooks. The operations of 1415 may be performed in accordance with examples as disclosed herein. In some examples, aspects of the operations of 1415 may be performed by a feedback transmitting component 1235 as described with reference to FIG. 12.

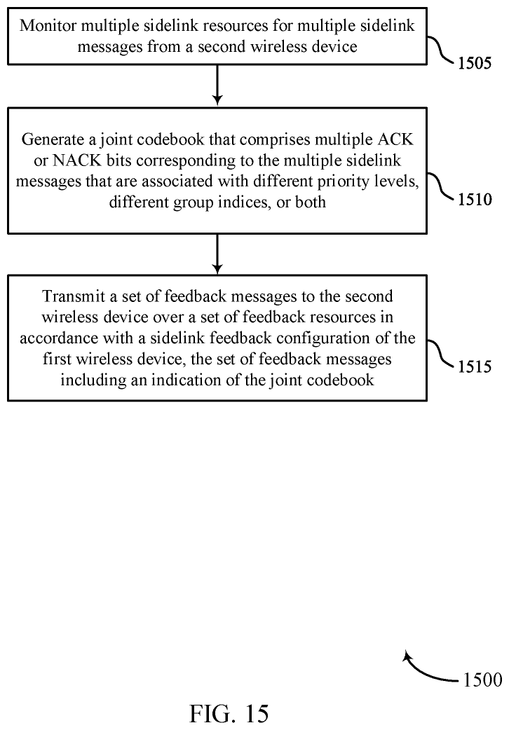

FIG. 15 shows a flowchart illustrating a method 1500 that supports techniques for enhanced sidelink feedback transmission in accordance with aspects of the present disclosure. The operations of the method 1500 may be implemented by a wireless device or its components as described herein. For example, the operations of the method 1500 may be performed by a wireless device as described with reference to FIGS. 1 through 13. In some examples, a wireless device may execute a set of instructions to control the functional elements of the wireless device to perform the described functions. Additionally or alternatively, the wireless device may perform aspects of the described functions using special-purpose hardware.

At 1505, the method may include monitoring multiple sidelink resources for multiple sidelink messages from a second wireless device. The operations of 1505 may be performed in accordance with examples as disclosed herein. In some examples, aspects of the operations of 1505 may be performed by a sidelink monitoring component 1225 as described with reference to FIG. 12.

At 1510, the method may include generating a joint codebook that includes multiple ACK or NACK bits corresponding to the multiple sidelink messages that are associated with different priority levels, different group indices, or both. The operations of 1510 may be performed in accordance with examples as disclosed herein. In some examples, aspects of the operations of 1510 may be performed by a codebook generating component 1230 as described with reference to FIG. 12.

At 1515, the method may include transmitting a set of feedback messages to the second wireless device over a set of feedback resources in accordance with a sidelink feedback configuration of the first wireless device, the set of feedback messages including an indication of the joint codebook. The operations of 1515 may be performed in accordance with examples as disclosed herein. In some examples, aspects of the operations of 1515 may be performed by a feedback transmitting component 1235 as described with reference to FIG. 12.

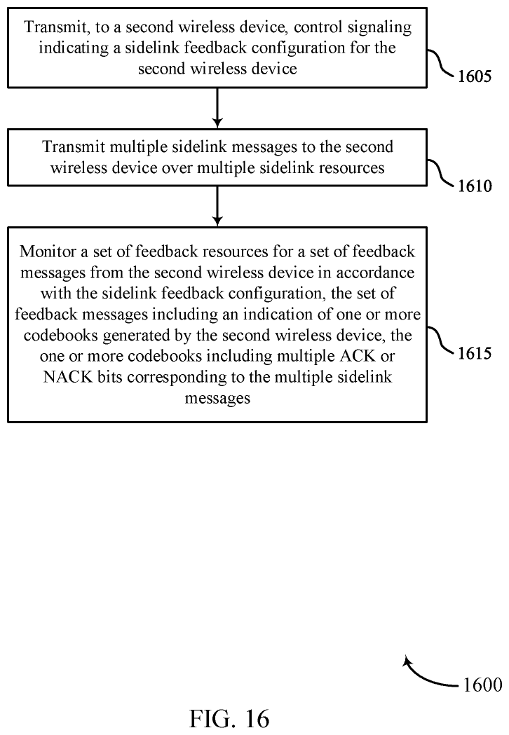

FIG. 16 shows a flowchart illustrating a method 1600 that supports techniques for enhanced sidelink feedback transmission in accordance with aspects of the present disclosure. The operations of the method 1600 may be implemented by a wireless device or its components as described herein. For example, the operations of the method 1600 may be performed by a wireless device as described with reference to FIGS. 1 through 13. In some examples, a wireless device may execute a set of instructions to control the functional elements of the wireless device to perform the described functions. Additionally or alternatively, the wireless device may perform aspects of the described functions using special-purpose hardware.

At 1605, the method may include transmitting, to a second wireless device, control signaling indicating a sidelink feedback configuration for the second wireless device. The operations of 1605 may be performed in accordance with examples as disclosed herein. In some examples, aspects of the operations of 1605 may be performed by a control signaling transmitter 1240 as described with reference to FIG. 12.

At 1610, the method may include transmitting multiple sidelink messages to the second wireless device over multiple sidelink resources. The operations of 1610 may be performed in accordance with examples as disclosed herein. In some examples, aspects of the operations of 1610 may be performed by a sidelink message transmitter 1245 as described with reference to FIG. 12.

At 1615, the method may include monitoring a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages. The operations of 1615 may be performed in accordance with examples as disclosed herein. In some examples, aspects of the operations of 1615 may be performed by a feedback monitoring component 1250 as described with reference to FIG. 12.

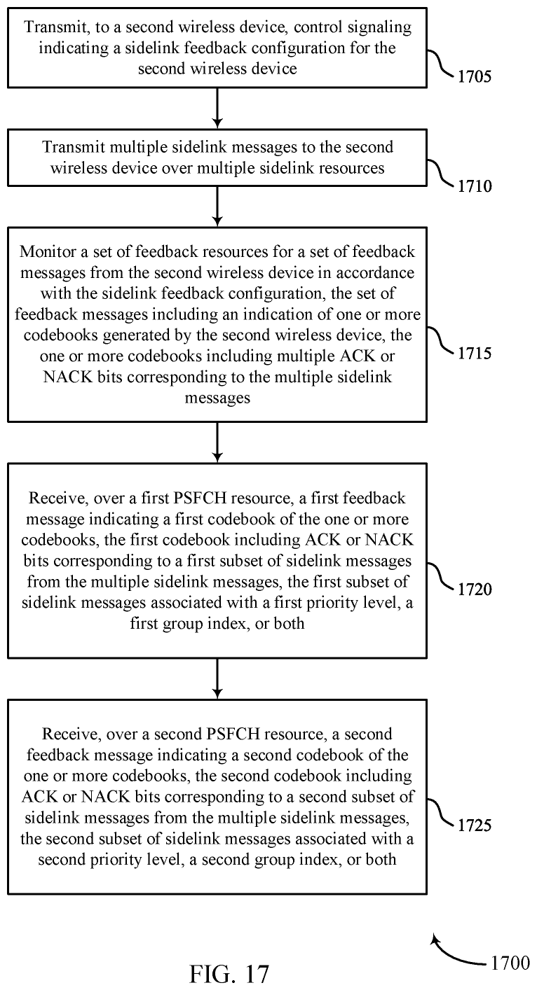

FIG. 17 shows a flowchart illustrating a method 1700 that supports techniques for enhanced sidelink feedback transmission in accordance with aspects of the present disclosure. The operations of the method 1700 may be implemented by a wireless device or its components as described herein. For example, the operations of the method 1700 may be performed by a wireless device as described with reference to FIGS. 1 through 13. In some examples, a wireless device may execute a set of instructions to control the functional elements of the wireless device to perform the described functions. Additionally or alternatively, the wireless device may perform aspects of the described functions using special-purpose hardware.

At 1705, the method may include transmitting, to a second wireless device, control signaling indicating a sidelink feedback configuration for the second wireless device. The operations of 1705 may be performed in accordance with examples as disclosed herein. In some examples, aspects of the operations of 1705 may be performed by a control signaling transmitter 1240 as described with reference to FIG. 12.

At 1710, the method may include transmitting multiple sidelink messages to the second wireless device over multiple sidelink resources. The operations of 1710 may be performed in accordance with examples as disclosed herein. In some examples, aspects of the operations of 1710 may be performed by a sidelink message transmitter 1245 as described with reference to FIG. 12.

At 1715, the method may include monitoring a set of feedback resources for a set of feedback messages from the second wireless device in accordance with the sidelink feedback configuration, the set of feedback messages including an indication of one or more codebooks generated by the second wireless device, the one or more codebooks including multiple ACK or NACK bits corresponding to the multiple sidelink messages. The operations of 1715 may be performed in accordance with examples as disclosed herein. In some examples, aspects of the operations of 1715 may be performed by a feedback monitoring component 1250 as described with reference to FIG. 12.

At 1720, the method may include receiving, over a first PSFCH resource, a first feedback message indicating a first codebook of the one or more codebooks, the first codebook including ACK or NACK bits corresponding to a first subset of sidelink messages from the multiple sidelink messages, the first subset of sidelink messages associated with a first priority level, a first group index, or both. The operations of 1720 may be performed in accordance with examples as disclosed herein. In some examples, aspects of the operations of 1720 may be performed by a feedback receiving component 1265 as described with reference to FIG. 12.

At 1725, the method may include receiving, over a second PSFCH resource, a second feedback message indicating a second codebook of the one or more codebooks, the second codebook including ACK or NACK bits corresponding to a second subset of sidelink messages from the multiple sidelink messages, the second subset of sidelink messages associated with a second priority level, a second group index, or both. The operations of 1725 may be performed in accordance with examples as disclosed herein. In some examples, aspects of the operations of 1725 may be performed by a feedback receiving component 1265 as described with reference to FIG. 12.

The following provides an overview of aspects of the present disclosure:

Aspect 1: A method for wireless communications at a first wireless device, comprising: monitoring a plurality of sidelink resources for a plurality of sidelink messages from a second wireless device; generating one or more codebooks comprising a plurality of acknowledgement or negative acknowledgement bits corresponding to the plurality of sidelink messages; and transmitting a set of feedback messages to the second wireless device over a set of feedback resources in accordance with a sidelink feedback configuration of the first wireless device, the set of feedback messages comprising an indication of the one or more codebooks.

Aspect 2: The method of aspect 1, wherein generating the one or more codebooks comprises: generating a joint codebook that comprises the plurality of acknowledgement or negative acknowledgement bits corresponding to the plurality of sidelink messages that are associated with different priority levels, different group indices, or both.

Aspect 3: The method of aspect 2, wherein generating the joint codebook comprises: generating a first subset of the joint codebook that comprises acknowledgement or negative acknowledgement bits corresponding to a first subset of sidelink messages from the plurality of sidelink messages, the first subset of sidelink messages associated with a first priority level; and generating a second subset of the joint codebook that comprises acknowledgement or negative acknowledgement bits corresponding to a second subset of sidelink messages from the plurality of sidelink messages, the second subset of sidelink messages associated with a second priority level that is different from the first priority level.

Aspect 4: The method of any of aspects 2 through 3, wherein generating the joint codebook comprises: generating a first subset of the joint codebook that comprises acknowledgement or negative acknowledgement bits corresponding to a first subset of sidelink messages from the plurality of sidelink messages, the first subset of sidelink messages associated with a first group index; and generating a second subset of the joint codebook that comprises acknowledgement or negative acknowledgement bits corresponding to a second subset of sidelink messages from the plurality of sidelink messages, the second subset of sidelink messages associated with a second group index.

Aspect 5: The method of aspect 4, wherein the first group index corresponds to a set of priority levels that are below a sidelink priority threshold and the second group index corresponds to a set of priority levels that are above the sidelink priority threshold.

Aspect 6: The method of any of aspects 2 through 5, further comprising: concatenating different subsets of the joint codebook in ascending order or descending order with respect to priority level or group index.

Aspect 7: The method of any of aspects 2 through 6, wherein transmitting the set of feedback messages comprises: transmitting an indication of the joint codebook over a physical sidelink feedback channel resource in accordance with the sidelink feedback configuration.

Aspect 8: The method of any of aspects 1 through 7, wherein the plurality of sidelink messages are associated with a respective plurality of priority levels, a respective plurality of group indices, or both; and the sidelink feedback configuration indicates a sidelink priority threshold, a first mapping between the respective plurality of priority levels and the one or more codebooks, a second mapping between the respective plurality of group indices and the one or more codebooks, or a combination thereof.

Aspect 9: The method of any of aspects 1 through 8, wherein the plurality of sidelink messages are multiplexed with respective instances of sidelink control information.

Aspect 10: The method of aspect 9, wherein each respective instance of sidelink control information comprises an indication of a counter sidelink assignment index and a total sidelink assignment index associated with a sidelink message from the plurality of sidelink messages.

Aspect 11: The method of aspect 10, wherein the counter sidelink assignment index and the total sidelink assignment index are specific to a priority level, a group index, or both.

Aspect 12: The method of aspect 10, wherein the counter sidelink assignment index and the total sidelink assignment index are applicable to different priority levels, different group indices, or both.

Aspect 13: The method of any of aspects 8 through 12, wherein generating the one or more codebooks comprises: generating a first codebook that comprises acknowledgement or negative acknowledgement bits corresponding to a first subset of sidelink messages from the plurality of sidelink messages, the first subset of sidelink messages associated with a first priority level; and generating a second codebook that comprises acknowledgement or negative acknowledgement bits corresponding to a second subset of sidelink messages from the plurality of sidelink messages, the second subset of sidelink messages associated with a second priority level that is different from the first priority level.

Aspect 14: The method of any of aspects 8 through 13, wherein generating the one or more codebooks comprises: generating a first codebook that comprises acknowledgement or negative acknowledgement bits corresponding to a first subset of sidelink messages from the plurality of sidelink messages, the first subset of sidelink messages associated with a first group index; and generating a second codebook that comprises acknowledgement or negative acknowledgement bits corresponding to a second subset of sidelink messages from the plurality of sidelink messages, the second subset of sidelink messages associated with a second group index that is different from the first group index.

Aspect 15: The method of any of aspects 8 through 14, wherein transmitting the set of feedback messages comprises: transmitting, over a first physical sidelink feedback channel resource, a first feedback message indicating a first codebook of the one or more codebooks, the first codebook comprising acknowledgement or negative acknowledgement bits corresponding to a first subset of sidelink messages from the plurality of sidelink messages, the first subset of sidelink messages associated with a first priority level, a first group index, or both; and transmitting, over a second physical sidelink feedback channel resource, a second feedback message indicating a second codebook of the one or more codebooks, the second codebook comprising acknowledgement or negative acknowledgement bits corresponding to a second subset of sidelink messages from the plurality of sidelink messages, the second subset of sidelink messages associated with a second priority level, a second group index, or both.

Aspect 16: The method of any of aspects 1 through 15, further comprising: receiving control signaling indicating one or more of a quantity of the one or more codebooks, a quantity of physical sidelink shared channel groups, a quantity of physical sidelink shared channel priority levels, a sidelink priority threshold, or an indication of whether to include acknowledgement or negative acknowledgement bits for sidelink messages associated with different priority levels, different group indices, or both in a joint codebook or in separate codebooks, wherein generating the one or more codebooks is based at least in part on the control signaling.

Aspect 17: The method of any of aspects 1 through 16, wherein the plurality of sidelink messages comprise unicast physical sidelink shared channel transmissions.

Aspect 18: The method of any of aspects 1 through 17, wherein the plurality of sidelink messages comprise unicast physical sidelink shared channel transmissions, groupcast physical sidelink shared channel transmissions, or both.

Aspect 19: The method of aspect 18, wherein the unicast physical sidelink shared channel transmissions and the groupcast physical sidelink shared channel transmissions are associated with separate counter sidelink assignment indices and separate total sidelink assignment indices.

Aspect 20: The method of any of aspects 18 through 19, wherein generating the one or more codebooks comprises: generating a joint codebook that comprises acknowledgement or negative acknowledgement bits corresponding to the unicast physical sidelink shared channel transmissions and the groupcast physical sidelink shared channel transmissions.

Aspect 21: The method of aspect 20, wherein generating the joint codebook comprises: generating a first subset of the joint codebook that comprises acknowledgement or negative acknowledgement bits corresponding to the unicast physical sidelink shared channel transmissions; and generating a second subset of the joint codebook that comprises acknowledgement or negative acknowledgement bits corresponding to the groupcast physical sidelink shared channel transmissions, wherein the first subset of the joint codebook precedes the second subset of the joint codebook.

Aspect 22: The method of any of aspects 20 through 21, wherein transmitting the set of feedback messages comprises: transmitting an indication of the joint codebook on a physical sidelink feedback channel resource in accordance with the sidelink feedback configuration.

Aspect 23: The method of any of aspects 18 through 19, wherein transmitting the set of feedback messages comprises: transmitting, over a first physical sidelink feedback channel resource, a first feedback message indicating a first codebook of the one or more codebooks, the first codebook comprising acknowledgement or negative acknowledgement bits corresponding to the unicast physical sidelink shared channel transmissions; and transmitting, over a second physical sidelink feedback channel resource, a second feedback message indicating a second codebook of the one or more codebooks, the second codebook comprising acknowledgement or negative acknowledgement bits corresponding to the groupcast physical sidelink shared channel transmissions.

Aspect 24: The method of any of aspects 18 through 23, further comprising: receiving radio resource control signaling indicating whether to include acknowledgement or negative acknowledgement bits for the unicast physical sidelink shared channel transmissions and acknowledgement or negative acknowledgement bits for the groupcast physical sidelink shared channel transmissions in a single codebook or in different codebooks, wherein generating the one or more codebooks is based at least in part on the radio resource control signaling.

Aspect 25: The method of any of aspects 1 through 24, further comprising: receiving radio resource control signaling indicating the sidelink feedback configuration, wherein transmitting the set of feedback messages to the second wireless device is based at least in part on the radio resource control signaling.

Aspect 26: The method of any of aspects 1 through 25, wherein the plurality of sidelink messages comprises a first set of groupcast physical sidelink shared channel transmissions associated with a first group identifier and a second set of groupcast physical sidelink shared channel transmissions associated with a second group identifier.

Aspect 27: The method of aspect 26, wherein generating the one or more codebooks comprises: generating a joint codebook that comprises acknowledgment or negative acknowledgement bits corresponding to the first set of groupcast physical sidelink shared channel transmissions and the second set of groupcast physical sidelink shared channel transmissions.

Aspect 28: The method of aspect 27, wherein generating the joint codebook comprises: generating a first subset of the joint codebook that comprises acknowledgment or negative acknowledgement bits corresponding to the first set of groupcast physical sidelink shared channel transmissions; and generating a second subset of the joint codebook that comprises acknowledgment or negative acknowledgement bits corresponding to the second set of groupcast physical sidelink shared channel transmissions.

Aspect 29: The method of any of aspects 27 through 28, further comprising: concatenating different subsets of the joint codebook in ascending order with respect to group identifier.

Aspect 30: The method of aspect 26, wherein generating the one or more codebooks comprises: generating a first codebook that comprises acknowledgement or negative acknowledgement bits corresponding to the first set of groupcast physical sidelink shared channel transmissions; and generating a second codebook that comprises acknowledgement or negative acknowledgement bits corresponding to the second set of groupcast physical sidelink shared channel transmissions.

Aspect 31: The method of aspect 30, wherein transmitting the set of feedback messages comprises: transmitting indications of the first codebook and the second codebook on different physical sidelink feedback channel resources in accordance with the sidelink feedback configuration.

Aspect 32: The method of any of aspects 26 through 31, further comprising: receiving radio resource control signaling indicating whether to include acknowledgment or negative acknowledgment bits for the first set of groupcast physical sidelink shared channel transmissions and acknowledgment or negative acknowledgment bits for the second set of groupcast physical sidelink shared channel transmissions in a single codebook or in different codebooks, wherein generating the one or more codebooks is based at least in part on the radio resource control signaling.

Aspect 33: The method of any of aspects 1 through 32, further comprising: retransmitting the set of feedback messages based at least in part on a result of a listen before talk procedure, an unsuccessful initial transmission, or both.

Aspect 34: The method of any of aspects 1 through 33, further comprising: receiving sidelink control information that indicates an acknowledgement feedback indicator associated with the plurality of sidelink messages; and determining whether one or both of a counter sidelink assignment index or a total sidelink assignment index for a subsequent sidelink message are reset based at least in part on a value of the acknowledgement feedback indicator.

Aspect 35: The method of aspect 34, wherein generating the one or more codebooks comprises: generating a codebook that comprises acknowledgement or negative acknowledgement bits corresponding to the plurality of sidelink messages that are associated with a same value of the acknowledgement feedback indicator.

Aspect 36: The method of any of aspects 1 through 35, further comprising: receiving sidelink control information indicating a physical sidelink shared channel group index, a hybrid automatic repeat request acknowledgement trigger field, or both; and determining whether to report hybrid automatic repeat request acknowledgement feedback for a first physical sidelink shared channel group, a second physical sidelink shared channel group, or both based at least in part on the sidelink control information.

Aspect 37: The method of aspect 36, wherein generating the one or more codebooks comprises: generating, based at least in part on a value of the hybrid automatic repeat request acknowledgement trigger field, the one or more codebooks that comprise hybrid automatic repeat request acknowledgement feedback for the first physical sidelink shared channel group and the second physical sidelink shared channel group, wherein the one or more codebooks are concatenated in ascending order with respect to physical sidelink shared channel group index.

Aspect 38: The method of any of aspects 1 through 37, further comprising: receiving sidelink control information indicating a counter sidelink assignment index, a first total sidelink assignment index associated with a first physical sidelink shared channel group, a first acknowledgement feedback indicator associated with the first physical sidelink shared channel group, or a combination thereof, and determining whether one or both of the first total sidelink assignment index or the counter sidelink assignment index for the first physical sidelink shared channel group are reset based at least in part on a value of the first acknowledgement feedback indicator.

Aspect 39: The method of aspect 38, further comprising: receiving sidelink control information indicating a second acknowledgement feedback indicator and a second total sidelink assignment index associated with a second physical sidelink shared channel group, wherein generating the one or more codebooks is based at least in part on receiving the sidelink control information.

Aspect 40: The method of any of aspects 1 through 39, further comprising: receiving radio resource control signaling indicating a sidelink control information format that comprises a group index field, a hybrid automatic repeat request acknowledgement trigger field, a first acknowledgment feedback indicator field associated with a first physical sidelink shared channel group, a second acknowledgement feedback indicator field associated with a second physical sidelink shared channel group, a counter sidelink assignment index field, a first total sidelink assignment index field associated with the first physical sidelink shared channel group, a second total sidelink assignment index field associated with the second physical sidelink shared channel group, or a combination thereof.

Aspect 41: A method for wireless communications at a first wireless device, comprising: transmitting, to a second wireless device, control signaling indicating a sidelink feedback configuration for the second wireless device; transmitting a plurality of sidelink messages to the second wireless device over a plurality of sidelink resources; and monitoring a set of feedback resources for a set of feedback messages from the second wireless device in accordance with the sidelink feedback configuration, the set of feedback messages comprising an indication of one or more codebooks generated by the second wireless device, the one or more codebooks comprising a plurality of acknowledgement or negative acknowledgement bits corresponding to the plurality of sidelink messages.

Aspect 42: The method of aspect 41, further comprising: receiving, from the second wireless device over a physical sidelink feedback channel resource, an indication of a joint codebook that comprises the plurality of acknowledgement or negative acknowledgement bits corresponding to the plurality of sidelink messages that are associated with different priority levels, different group indices, or both.

Aspect 43: The method of any of aspects 41 through 42, wherein the plurality of sidelink messages are associated with a respective plurality of priority levels, a respective plurality of group indices, or both; and the sidelink feedback configuration indicates a sidelink priority threshold, a first mapping between the respective plurality of priority levels and the one or more codebooks, a second mapping between the respective plurality of group indices and the one or more codebooks, or a combination thereof.

Aspect 44: The method of any of aspects 41 through 43, wherein the plurality of sidelink messages are multiplexed with respective instances of sidelink control information.

Aspect 45: The method of aspect 44, wherein each respective instance of sidelink control information comprises an indication of a counter sidelink assignment index and a total sidelink assignment index associated with a sidelink message from the plurality of sidelink messages.

Aspect 46: The method of aspect 45, wherein the counter sidelink assignment index and the total sidelink assignment index are specific to a priority level, a group index, or both.

Aspect 47: The method of aspect 45, wherein the counter sidelink assignment index and the total sidelink assignment index are applicable to different priority levels, different group indices, or both.

Aspect 48: The method of any of aspects 43 through 47, further comprising: receiving, over a first physical sidelink feedback channel resource, a first feedback message indicating a first codebook of the one or more codebooks, the first codebook comprising acknowledgement or negative acknowledgement bits corresponding to a first subset of sidelink messages from the plurality of sidelink messages, the first subset of sidelink messages associated with a first priority level, a first group index, or both; and receiving, over a second physical sidelink feedback channel resource, a second feedback message indicating a second codebook of the one or more codebooks, the second codebook comprising acknowledgement or negative acknowledgement bits corresponding to a second subset of sidelink messages from the plurality of sidelink messages, the second subset of sidelink messages associated with a second priority level, a second group index, or both.

Aspect 49: The method of any of aspects 41 through 48, wherein transmitting the control signaling comprises: transmitting radio resource control signaling that indicates a quantity of the one or more codebooks, a quantity of physical sidelink shared channel groups, a quantity of physical sidelink shared channel priority levels, a sidelink priority threshold, or a combination thereof.

Aspect 50: The method of any of aspects 41 through 49, wherein the plurality of sidelink messages comprise unicast physical sidelink shared channel transmissions.

Aspect 51: The method of any of aspects 41 through 50, wherein the plurality of sidelink messages comprise unicast physical sidelink shared channel transmissions, groupcast physical sidelink shared channel transmissions, or both.

Aspect 52: The method of aspect 51, wherein the unicast physical sidelink shared channel transmissions and the groupcast physical sidelink shared channel transmissions are associated with separate counter sidelink assignment indices and separate total sidelink assignment indices.

Aspect 53: The method of any of aspects 51 through 52, further comprising: receiving, over a physical sidelink feedback channel resource, a feedback message indicating a joint codebook that comprises acknowledgement or negative acknowledgment bits corresponding to the unicast physical sidelink shared channel transmissions and acknowledgement or negative acknowledgment bits corresponding to the groupcast physical sidelink shared channel transmissions.

Aspect 54: The method of any of aspects 51 through 52, further comprising: receiving, over a first physical sidelink feedback channel resource, a first feedback message indicating a first codebook that comprises acknowledgement or negative acknowledgement bits corresponding to the unicast physical sidelink shared channel transmissions; and receiving, over a second physical sidelink feedback channel resource, a second feedback message indicating a second codebook that comprises acknowledgement or negative acknowledgement bits corresponding to the groupcast physical sidelink shared channel transmissions.

Aspect 55: The method of any of aspects 51 through 54, wherein transmitting the control signaling comprises: transmitting radio resource control signaling that indicates whether to include acknowledgement or negative acknowledgement bits for the unicast physical sidelink shared channel transmissions and acknowledgement or negative acknowledgement bits for the groupcast physical sidelink shared channel transmissions in a single codebook or in different codebooks.

Aspect 56: The method of any of aspects 41 through 55, wherein the plurality of sidelink messages comprises a first set of groupcast physical sidelink shared channel transmissions associated with a first group identifier and a second set of groupcast physical sidelink shared channel transmissions associated with a second group identifier.

Aspect 57: The method of aspect 56, wherein transmitting the control signaling comprises: transmitting radio resource control signaling that indicates whether to include acknowledgment or negative acknowledgment bits for the first set of groupcast physical sidelink shared channel transmissions and acknowledgment or negative acknowledgment bits for the second set of groupcast physical sidelink shared channel transmissions in a single codebook or in different codebooks.

Aspect 58: The method of any of aspects 55 through 57, further comprising: receiving, over a first physical sidelink feedback channel resource, a first feedback message indicating a first codebook that comprises acknowledgement or negative acknowledgement bits corresponding to a first set of groupcast physical sidelink shared channel transmissions; and receiving, over a second physical sidelink feedback channel resource, a second feedback message indicating a second codebook that comprises acknowledgement or negative acknowledgement bits corresponding to a second set of groupcast physical sidelink shared channel transmissions.

Aspect 59: The method of any of aspects 55 through 57, further comprising: receiving a feedback message indicating a codebook that comprises acknowledgement or negative acknowledgement bits corresponding to the plurality of sidelink messages that are associated with a same acknowledgment feedback indicator value.

Aspect 60: The method of any of aspects 41 through 59, further comprising: transmitting sidelink control information indicating a physical sidelink shared channel group index, a hybrid automatic repeat request acknowledgement trigger field, a first acknowledgement feedback indicator associated with a first physical sidelink shared channel group, a second acknowledgement feedback indicator associated with a second physical sidelink shared channel group, a counter sidelink assignment index, a first total sidelink assignment index associated with the first physical sidelink shared channel group, a second total sidelink assignment index associated with the second physical sidelink shared channel group, or a combination thereof.

Aspect 61: The method of any of aspects 41 through 60, wherein transmitting the control signaling comprises: transmitting radio resource control signaling indicating a sidelink control information format that comprises a group index field, a hybrid automatic repeat request acknowledgement trigger field, a first acknowledgment feedback indicator field associated with a first physical sidelink shared channel group, a second acknowledgement feedback indicator field associated with a second physical sidelink shared channel group, a counter sidelink assignment index field, a first total sidelink assignment index field associated with the first physical sidelink shared channel group, a second total sidelink assignment index field associated with the second physical sidelink shared channel group, or a combination thereof.

Aspect 62: The method of any of aspects 41 through 61, wherein transmitting the control signaling comprises: transmitting sidelink control information indicating a counter sidelink assignment index, a total sidelink assignment index, an acknowledgement feedback indicator, or a combination thereof, wherein a value of the acknowledgement feedback indicator indicates whether one or both of the total sidelink assignment index or the counter sidelink assignment index are reset for a physical sidelink shared channel group.

Aspect 63: An apparatus for wireless communications at a first wireless device, comprising a processor; memory coupled with the processor; and instructions stored in the memory and executable by the processor to cause the apparatus to perform a method of any of aspects 1 through 40.

Aspect 64: An apparatus for wireless communications at a first wireless device, comprising at least one means for performing a method of any of aspects 1 through 40.

Aspect 65: A non-transitory computer-readable medium storing code for wireless communications at a first wireless device, the code comprising instructions executable by a processor to perform a method of any of aspects 1 through 40.

Aspect 66: An apparatus for wireless communications at a first wireless device, comprising a processor; memory coupled with the processor; and instructions stored in the memory and executable by the processor to cause the apparatus to perform a method of any of aspects 41 through 62.

Aspect 67: An apparatus for wireless communications at a first wireless device, comprising at least one means for performing a method of any of aspects 41 through 62.

Aspect 68: A non-transitory computer-readable medium storing code for wireless communications at a first wireless device, the code comprising instructions executable by a processor to perform a method of any of aspects 41 through 62.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a first wireless device, comprising:
monitoring a plurality of sidelink resources for a plurality of sidelink messages from a second wireless device;
generating one or more codebooks comprising a plurality of acknowledgement or negative acknowledgement bits corresponding to the plurality of sidelink messages; and
transmitting a set of feedback messages to the second wireless device over a set of feedback resources in accordance with a sidelink feedback configuration of the first wireless device, the set of feedback messages comprising an indication of the one or more codebooks.

2. The method of claim 1, wherein generating the one or more codebooks comprises:
generating a joint codebook that comprises the plurality of acknowledgement or negative acknowledgement bits corresponding to the plurality of sidelink messages that are associated with different priority levels, different group indices, or both.

3. The method of claim 2, wherein generating the joint codebook comprises:
generating a first subset of the joint codebook that comprises acknowledgement or negative acknowledgement bits corresponding to a first subset of sidelink messages from the plurality of sidelink messages, the first subset of sidelink messages associated with a first priority level; and
generating a second subset of the joint codebook that comprises acknowledgement or negative acknowledgement bits corresponding to a second subset of sidelink messages from the plurality of sidelink messages, the second subset of sidelink messages associated with a second priority level that is different from the first priority level.

4. The method of claim 2, wherein generating the joint codebook comprises:
generating a first subset of the joint codebook that comprises acknowledgement or negative acknowledgement bits corresponding to a first subset of sidelink messages from the plurality of sidelink messages, the first subset of sidelink messages associated with a first group index; and
generating a second subset of the joint codebook that comprises acknowledgement or negative acknowledgement bits corresponding to a second subset of sidelink messages from the plurality of sidelink messages, the second subset of sidelink messages associated with a second group index.

5. The method of claim 4, wherein the first group index corresponds to a set of priority levels that are below a sidelink priority threshold and the second group index corresponds to a set of priority levels that are above the sidelink priority threshold.

6. The method of claim 2, further comprising:
concatenating different subsets of the joint codebook in ascending order or descending order with respect to priority level or group index.

7. The method of claim 2, wherein transmitting the set of feedback messages comprises:
transmitting an indication of the joint codebook over a physical sidelink feedback channel resource in accordance with the sidelink feedback configuration.

8. The method of claim 1, wherein:
the plurality of sidelink messages are associated with a respective plurality of priority levels, a respective plurality of group indices, or both; and
the sidelink feedback configuration indicates a sidelink priority threshold, a first mapping between the respective plurality of priority levels and the one or more codebooks, a second mapping between the respective plurality of group indices and the one or more codebooks, or a combination thereof.

9. The method of claim 1, wherein the plurality of sidelink messages are multiplexed with respective instances of sidelink control information.

10. The method of claim 9, wherein each respective instance of sidelink control information comprises an indication of a counter sidelink assignment index and a total sidelink assignment index associated with a sidelink message from the plurality of sidelink messages.

11. The method of claim 10, wherein the counter sidelink assignment index and the total sidelink assignment index are specific to a priority level, a group index, or both.

12. The method of claim 10, wherein the counter sidelink assignment index and the total sidelink assignment index are applicable to different priority levels, different group indices, or both.

13. The method of claim 1, wherein generating the one or more codebooks comprises:
generating a first codebook that comprises acknowledgement or negative acknowledgement bits corresponding to a first subset of sidelink messages from the plurality of sidelink messages, the first subset of sidelink messages associated with a first priority level; and
generating a second codebook that comprises acknowledgement or negative acknowledgement bits corresponding to a second subset of sidelink messages from the plurality of sidelink messages, the second subset of sidelink messages associated with a second priority level that is different from the first priority level.

14. The method of claim 1, wherein generating the one or more codebooks comprises:
generating a first codebook that comprises acknowledgement or negative acknowledgement bits corresponding to a first subset of sidelink messages from the plurality of sidelink messages, the first subset of sidelink messages associated with a first group index; and
generating a second codebook that comprises acknowledgement or negative acknowledgement bits corresponding to a second subset of sidelink messages from the plurality of sidelink messages, the second subset of sidelink messages associated with a second group index that is different from the first group index.

15. The method of claim 1, wherein transmitting the set of feedback messages comprises:
transmitting, over a first physical sidelink feedback channel resource, a first feedback message indicating a first codebook of the one or more codebooks, the first codebook comprising acknowledgement or negative acknowledgement bits corresponding to a first subset of sidelink messages from the plurality of sidelink messages, the first subset of sidelink messages associated with a first priority level, a first group index, or both; and
transmitting, over a second physical sidelink feedback channel resource, a second feedback message indicating a second codebook of the one or more codebooks, the second codebook comprising acknowledgement or negative acknowledgement bits corresponding to a second subset of sidelink messages from the plurality of sidelink messages, the second subset of sidelink messages associated with a second priority level, a second group index, or both.

16. The method of claim 1, further comprising:
receiving control signaling indicating one or more of a quantity of the one or more codebooks, a quantity of physical sidelink shared channel groups, a quantity of physical sidelink shared channel priority levels, a sidelink priority threshold, or an indication of whether to include acknowledgement or negative acknowledgement bits for sidelink messages associated with different priority levels, different group indices, or both in a joint codebook or in separate codebooks, wherein generating the one or more codebooks is based at least in part on the control signaling.

17. The method of claim 1, wherein the plurality of sidelink messages comprise unicast physical sidelink shared channel transmissions.

18. The method of claim 1, wherein the plurality of sidelink messages comprise unicast physical sidelink shared channel transmissions, groupcast physical sidelink shared channel transmissions, or both.

19. The method of claim 18, wherein the unicast physical sidelink shared channel transmissions and the groupcast physical sidelink shared channel transmissions are associated with separate counter sidelink assignment indices and separate total sidelink assignment indices.

20.-32. (canceled)

33. The method of claim 1, further comprising:
retransmitting the set of feedback messages based at least in part on a result of a listen before talk procedure, an unsuccessful initial transmission, or both.

34. The method of claim 1, further comprising:
receiving sidelink control information that indicates an acknowledgement feedback indicator associated with the plurality of sidelink messages; and
determining whether one or both of a counter sidelink assignment index or a total sidelink assignment index for a subsequent sidelink message are reset based at least in part on a value of the acknowledgement feedback indicator.

35. The method of claim 34, wherein generating the one or more codebooks comprises:
generating a codebook that comprises acknowledgement or negative acknowledgement bits corresponding to the plurality of sidelink messages that are associated with a same value of the acknowledgement feedback indicator.

36. The method of claim 1, further comprising:
receiving sidelink control information indicating a physical sidelink shared channel group index, a hybrid automatic repeat request acknowledgement trigger field, or both; and
determining whether to report hybrid automatic repeat request acknowledgement feedback for a first physical sidelink shared channel group, a second physical sidelink shared channel group, or both based at least in part on the sidelink control information.

37. The method of claim 36, wherein generating the one or more codebooks comprises:
generating, based at least in part on a value of the hybrid automatic repeat request acknowledgement trigger field, the one or more codebooks that comprise hybrid automatic repeat request acknowledgement feedback for the first physical sidelink shared channel group and the second physical sidelink shared channel group, wherein the one or more codebooks are concatenated in ascending order with respect to physical sidelink shared channel group index.

38. The method of claim 1, further comprising:
receiving sidelink control information indicating a counter sidelink assignment index, a first total sidelink assignment index associated with a first physical sidelink shared channel group, a first acknowledgement feedback indicator associated with the first physical sidelink shared channel group, or a combination thereof, and
determining whether one or both of the first total sidelink assignment index or the counter sidelink assignment index for the first physical sidelink shared channel group are reset based at least in part on a value of the first acknowledgement feedback indicator.

39. The method of claim 38, further comprising:
receiving sidelink control information indicating a second acknowledgement feedback indicator and a second total sidelink assignment index associated with a second physical sidelink shared channel group, wherein generating the one or more codebooks is based at least in part on receiving the sidelink control information.

40. The method of claim 1, further comprising:
receiving radio resource control signaling indicating a sidelink control information format that comprises a group index field, a hybrid automatic repeat request acknowledgement trigger field, a first acknowledgment feedback indicator field associated with a first physical sidelink shared channel group, a second acknowledgement feedback indicator field associated with a second physical sidelink shared channel group, a counter sidelink assignment index field, a first total sidelink assignment index field associated with the first physical sidelink shared channel group, a second total sidelink assignment index field associated with the second physical sidelink shared channel group, or a combination thereof.

41.-62. (canceled)

63. An apparatus for wireless communications at a first wireless device, comprising:
a processor;
memory coupled with the processor; and
instructions stored in the memory and executable by the processor to cause the apparatus to:
monitor a plurality of sidelink resources for a plurality of sidelink messages from a second wireless device;
generate one or more codebooks comprising a plurality of acknowledgement or negative acknowledgement bits corresponding to the plurality of sidelink messages; and
transmit a set of feedback messages to the second wireless device over a set of feedback resources in accordance with a sidelink feedback configuration of the first wireless device, the set of feedback messages comprising an indication of the one or more codebooks.

64. (canceled)

65. An apparatus for wireless communications at a first wireless device, comprising:
means for monitoring a plurality of sidelink resources for a plurality of sidelink messages from a second wireless device;
means for generating one or more codebooks comprising a plurality of acknowledgement or negative acknowledgement bits corresponding to the plurality of sidelink messages; and
means for transmitting a set of feedback messages to the second wireless device over a set of feedback resources in accordance with a sidelink feedback configuration of the first wireless device, the set of feedback messages comprising an indication of the one or more codebooks.

66. (canceled)

67. A non-transitory computer-readable medium storing code for wireless communications at a first wireless device, the code comprising instructions executable by a processor to:
monitor a plurality of sidelink resources for a plurality of sidelink messages from a second wireless device;
generate one or more codebooks comprising a plurality of acknowledgement or negative acknowledgement bits corresponding to the plurality of sidelink messages; and
transmit a set of feedback messages to the second wireless device over a set of feedback resources in accordance with a sidelink feedback configuration of the first wireless device, the set of feedback messages comprising an indication of the one or more codebooks.

68. (canceled)
